(19) United States
(12) Patent Application Publication
(10) Pub. No.: US 2015/0205822 A1
(43) Pub. Date: Jul. 23, 2015

(54) Methods and Systems for Contact Management

(71) Applicant: HUMIN, INC., San Francisco, CA (US)

(72) Inventors: Ankur Jain, San Francisco, CA (US); Purshotam Rajani, San Francisco, CA (US); Sinan Aral, San Francisco, CA (US); Daniel O'Shea, San Francisco, CA (US); Chetan Surpur, San Francisco, CA (US); Ian Murray, San Francisco, CA (US); Ryan Mick, San Francisco, CA (US); Clara Zavani, San Francisco, CA (US); Joe Dao, San Francisco, CA (US); John Ullman, San Francisco, CA (US); Kenny Liou, San Francisco, CA (US); Jacob Topper, San Francisco, CA (US); Jaclyn Chen, San Francisco, CA (US); Arielle Zuckerberg, San Francisco, CA (US); Daniel Pourbaba, San Francisco, CA (US); Jonathan Shriftman, San Francisco, CA (US); Jacob Medwell, San Francisco, CA (US); David Wyler, The Hague (NL)

(21) Appl. No.: 14/599,409

(22) Filed: Jan. 16, 2015

Related U.S. Application Data
(60) Provisional application No. 61/928,990, filed on Jan. 17, 2014.

(51) Int. Cl. G06F 17/30

(52) U.S. Cl. CPC G06F 17/30289; G06F 17/30386; G06F 17/30312

(57) ABSTRACT

A method for contact management comprises retrieving, using a mobile electronic device of a user, contact information from multiple external sources. The method next comprises storing said contact information in a memory location of said mobile electronic device. Next, the method comprises determining with a computer processor whether contact information from a portion of said multiple sources at least partially overlaps with contact information from a remainder of said multiple sources. The method next comprises either merging the contact information to generate a consolidated contact record or splitting the contact information to generate split contact records based on the determining the overlap. And then the method comprises storing said consolidated contact record or split contact records in a memory location of said mobile electronic device.

### CROSS-REFERENCE

This application claims the benefit of U.S. Provisional Application No. 61/928,990, filed Jan. 17, 2014, which is entirely incorporated herein by reference.

### BACKGROUND

A user can have and maintain a database of contacts with contact information relating to persons or entities that the user knows or wishes to know. Such database can be maintained on a server or social network web site, for instance.

Social networking web sites, such as Facebook® and LinkedIn®, enable users to search for and find other users, and keep in touch with users with whom they are connected. In some cases, users are searched for and matched on the basis of the degree of separation from one user to another, such as once removed or twice removed. A contact network may be built up consisting of direct connections and the connections of each of their connections (termed second-degree connections).

There are various services and applications available that enable a user to maintain a database of contacts, which may include users and entities (e.g., companies) that the user knows or may know. LinkedIn®, for instance, allows registered users to maintain a list of contact details of people with whom they are linked to, called “connections.” A user may search for other users, and once another user is found, that user may be added to a contact database (e.g., contact list) of the user that initiated the search.

There is also software available that enables a user to have and maintain a database of contacts. Such software may enable a user to input contact information for other users, and use that contact information to communicate with other users.

### SUMMARY

The growing number of social networking services and approaches for keeping contacts has made it increasingly difficult to maintain a uniform contacts database. A user may have a certain list of contacts on a social network (e.g., Facebook®, LinkedIn®, Flickr®, Skype®, Instagram®, Pinterest®, Twitter®, Tumbler®, etc.) that differs from a list stored locally on the user's electronic device. Even if there is overlap between the lists, such as if both lists have common contacts, the contact information for the common contacts may be different. For example, the contact information of a person on the social network may be up-to-date, but the contact information of the person on the list stored locally on the user's electronic device may be outdated. This presents the problem that the user may not be able to effectively and reliably communicate with the person.

The present disclosure provides systems and methods that enable a user to maintain a consolidated database (e.g., list) of contacts in a single location and to search, interact with and initiate communication with the contacts. The database may be populated from various locations, such as social networks, databases containing public data, and local contacts lists. The database may grow and be updated with changing contact information. For example, if a user has contacts on a social network and contacts in a local address book on an electronic device of the user, systems and methods of the present disclosure can enable the user to generate a consolidated contacts list on the electronic device and keep that list updated as contact and biographical information on the social network or the local address book changes. These changes may also update the visibility of information about second-degree connections to the user.

In an aspect, the present disclosure provides a mobile application for execution on various hardware and software settings, or as a web-based service, to manage a contacts database of a user. The mobile application can enable management of contacts of the user and communication between the user and the contacts. In some embodiments, the mobile application advantageously maintains and updates the contacts locally on the mobile application as opposed to a server to minimize risks to privacy and to make such information available while the user is offline. The mobile application can enable the user to maintain contacts across various services, such as social networks, thereby providing the user the ability to have an up-to-date contacts database with little to no effort.

In another aspect, the present disclosure provides a user-adaptive contacts management application that utilizes one or more of a social network, artificial intelligence algorithms and machine learning algorithms to integrate contacts and contextual information from a multitude of online and offline sources.

In another aspect, the present disclosure provides a method for contact management from multiple sources of contact information, comprising (a) retrieving, with a mobile electronic device of a user, contact information from multiple external sources of contact information over a network; (b) storing the contact information in a memory location of the mobile electronic device; (c) determining with a computer processor whether contact information from a portion of the multiple sources at least partially overlaps with contact information from a remainder of the multiple sources; (d) based on the determining of (c), (i) if there is overlap between the portion of the multiple sources and the remainder of the multiple sources such that the contact information is indicative of a single contact, merging overlapping contact information to generate a consolidated contact record corresponding to a distinct contact, which consolidated contact record has a single set of contact information, or (ii) if the contact information is indicative of two distinct contacts, splitting the contact information to generate split contact records for the two distinct contacts having different sets of contact information; and (e) storing the consolidated contact record or split contact records in a memory location having a database of contact records of the mobile electronic device.

In some embodiments, the method further comprises determining a level of overlap between the portion of the multiple sources and the remainder of the multiple sources, and merging the overlapping contact information if the level of overlap is greater than 50%. In some embodiments, at least one of the multiple external sources of contact information is a social network in communication with the mobile electronic device of the user. In some embodiments, (a) further comprises retrieving contact information from a contact database on the mobile electronic device. In some embodiments, the multiple external sources further includes an additional social network. In some embodiments, (c) and/or (d) are performed without using a central computer server. In some embodiments, (c) and/or (d) are performed by the mobile electronic device. In some embodiments, the computer processor is a part of the mobile electronic device. In some embodiments, the computer processor is a part of another electronic device, and further, the another electronic device is a computer server. In some embodiments, the contact information from the multiple external sources includes identifying information selected from the group consisting of name(s), physical address(es), electronic mail address(es) and telephone number(s). In some embodiments, the method may further comprise displaying the consolidated contact record or split contact records on a user interface of the mobile electronic device, and in some embodiments the consolidated contact record or split contact records are displayed on contact cards on the user interface. In some embodiments, the consolidated contact record or split contact records include(s) contact information selected from the group consisting of contact name(s), physical address(es), electronic mail address(es) and telephone number(s).

In another aspect, the present disclosure comprises a method for contact management from multiple sources of contact information, comprising (a) retrieving, with an electronic device of a user, contact information from multiple external sources of contact information over a network, wherein the electronic device is not a central computer server; (b) storing the contact information in a memory location of the electronic device; (c) determining with a computer processor whether contact information from a portion of the multiple sources at least partially overlaps with contact information from a remainder of the multiple sources; (d) based on the determining of (c), (i) if there is overlap between the portion of the multiple sources and the remainder of the multiple sources, merging overlapping contact information to generate a consolidated contact record corresponding to a distinct contact, which consolidated contact record has a single set of contact information, or (ii) if the contact information is indicative of two distinct contacts, splitting the contact information to generate split contact records for the two distinct contacts; and (e) storing the consolidated contact record or split contact records in a memory location having a database of contact records of the electronic device.

In some embodiments, at least one of the multiple external sources of contact information is a social network in communication with the mobile electronic device of the user. In some embodiments, (a) further comprises retrieving contact information from a contact database on the electronic device. In some embodiments, (c) and/or (d) are performed without using a central computer server. In some embodiments, (c) and/or (d) are performed by the electronic device. In some embodiments, the computer processor is a part of the electronic device. In some embodiments, the computer processor is a part of another electronic device, and in further embodiments the another electronic device is a computer server. In some embodiments, the method further comprises displaying the consolidated contact record or split contact records on a user interface of the electronic device. In some embodiments of the invention the electronic device is in communication with other electronic devices of other users over the network.

In a further aspect, the present disclosure comprises a mobile electronic device programmed for contact management from multiple sources of contact information over a network, comprising a communication interface that brings the mobile electronic device in communication with multiple external sources of contact information, at least one of which multiple sources is a social network in network communication with the mobile electronic device over the network; computer memory that stores contact information; and a computer processor coupled to the communication interface and the computer memory, wherein the computer processor is programmed to (a) retrieve contact information from the multiple external sources; (b) store the contact information in the computer memory; (c) determine whether contact information from a portion of the multiple sources at least partially overlaps with contact information from a remainder of the multiple sources; (d) based on (c), (i) if there is overlap between the portion of the multiple sources and the remainder of the multiple sources, merge overlapping contact information to generate a consolidated contact record corresponding to a distinct contact, which consolidated contact record has a single set of contact information, or (ii) if the contact information is indicative of two distinct contacts, split the contact information to generate split contact records for the two distinct contacts; and (e) store the consolidated contact record or split contact records in the computer memory.

In some embodiments, the mobile electronic device further comprises an electronic display coupled to the computer processor, wherein the electronic display includes a user interface that displays the consolidated contact record or split contact records, and further, the user interface may include one or more graphical elements that differentiate the consolidated contact record or split contact records.

In another aspect, the present disclosure comprises a method for identifying contextually-relevant contacts based on contextual information related to a user, comprising (a) receiving a search query based on input from a user in a user interface of an electronic display of a mobile electronic device of the user; (b) conducting, with the aid of a computer processor, a search of one or more databases or lists of contact information directed to the search query, wherein the one or more databases or lists of contact information comprises (i) one or more contacts of the user and (ii) an identified relationship between the user and the one or more contacts, and wherein the one or more databases or lists of contact information are included in the mobile electronic device; (c) determining the contextual information including a context of the user and a context of at least one of the one or more contacts and the identified relationship; (d) ordering search results received from the search based on the contextual information determined in (c) to provide the contextually relevant contacts; and (e) displaying the search results on the user interface, thereby permitting the user to readily identify the contextually-relevant contacts based on the contextual information.

In some embodiments, the context is selected from the group consisting of work, social, educational, entertainment, geographic, and temporal context. In some embodiments, the one or more contacts include a primary contact and/or a secondary contact, and in further embodiments, (d) comprises ordering the search results based on (i) the context of the user, (ii) context of a contact of the user and/or a context of a secondary contact of the user, and (iii) a context of an identified relationship between the user and the contact of the user and/or a context of an identified relationship between the user and the secondary contact of the user. In some embodiments, (c) comprises determining a context of the user and contexts of the one or more contacts and the identified relationship. In some embodiments, in (d) the contacts are ordered by contextual relevance based on the contextual information determined in (c). In some embodiments, the method further comprises retrieving the one or more databases or lists of contact information from a central computer server in communication with the mobile electronic device, and in further embodiments, (b) is performed without directly using the central computer server. In some embodiments, the search query includes geographic and/or temporal information. In some embodiments, the method further comprises determining an identified relationship between the user and an individual contact among the one more contacts by executing an algorithm to assign a discrete or continuous score that is indicative of a strength of the identified relationship, and in further embodiments, the algorithm is an artificial intelligence algorithm and/or machine learning algorithm that incorporates predictive features describing (i) characteristics of users, including the user, (ii) characteristics of relationships between the users, (iii) characteristics of network(s) that connect the users, (iv) activities of the users or activities that characterize the relationships between the users, (v) strength scores and/or (vi) characterizations indicative of the strength of the identified relationship; and in further embodiments, the contextual information includes the discrete or continuous score.

In another aspect, the present disclosure provides a method for identifying contextually-relevant contacts based on contextual information related to a user, comprising (a) receiving a search query based on input from a user in a user interface of an electronic display of an electronic device of the user; (b) conducting, with the aid of a computer processor of the electronic device, a search of one or more databases or lists of contact information directed to the search query, wherein the one or more databases or lists of contact information comprises (i) one or more contacts of the user and (ii) an identified relationship between the user and the one or more contacts, wherein the one or more databases or lists of contact information are retrieved and stored on the electronic device from a central computer server; (c) determining the contextual information including a context of the user and a context of at least one of the one or more contacts and the identified relationship; (d) ordering search results received from the search based on the contextual information determined in (c) to provide the contextually relevant contacts; and (e) displaying the search results on the user interface, thereby permitting the user to readily identify the contextually-relevant contacts based on the contextual information.

In some embodiments, the context is selected from the group consisting of work, social, educational, entertainment, geographic, and temporal context. In some embodiments, the one or more contacts include a primary contact and/or a secondary contact, and in further embodiments, (d) comprises ordering the search results based on (i) the context of the user, (ii) context of a contact of the user and/or a context of a secondary contact of the user, and (iii) a context of an identified relationship between the user and the contact of the user and/or a context of an identified relationship between the user and the secondary contact of the user. In some embodiments, (c) comprises determining a context of the user and contexts of the one or more contacts and the identified relationship. In some embodiments, in (d) the contacts are ordered by contextual relevance based on the contextual information determined in (c). In some embodiments, (b) is performed without directly using the central computer server. In some embodiments, the search query includes geographic and/or temporal information.

In another aspect, the present disclosure provides a mobile electronic device programmed to identify contextually-relevant contacts based on contextual information related to a user, comprising an electronic display including a user interface for receiving a search query based on input from a user; computer memory for storing one or more databases or lists of contact information, wherein the one or more databases or lists of contact information comprises (i) one or more contacts of the user and (ii) an identified relationship between the user and the one or more contacts; and a computer processor coupled to the electronic display and the computer memory, wherein the computer processor is programmed to (i) receive the search query from the user interface, (ii) conduct a search of the one or more databases or lists of contact information directed to the search query, (iii) determine the contextual information including a context of the user and a context of at least one of the one or more contacts and the identified relationship, (iv) order search results received from the search based on the contextual information determined in (iii) provide the contextually relevant contacts, and (v) provide the search results for display on the user interface, thereby permitting the user to readily identify the contextually-relevant contacts based on the contextual information.

In a further aspect, the present disclosure provides a method for computing relative strengths of relationships between contacts that are embedded in a network of contacts, comprising (a) receiving an input of at least two contacts from one or more databases or lists of contact information of contacts in a network of contacts; (b) assigning, with the aid of a computer processor, a discrete or continuous score to describe a strength of a relationship between the two contacts, wherein the score is determined by artificial intelligence algorithms and/or machine learning algorithms stored in a memory location and implemented upon execution by the computer processor, which algorithms incorporate predictive features describing (i) characteristics of users, (ii) characteristics of a relationship between the users, (iii) characteristics of networks that connect the users, (iv) activities of the users or activities that characterize the relationship between the users, (v) strength scores and/or (vi) other characterizations of a strength of a user's relationship to another user that have been manually or automatically entered by the users; and (c) inputting the score into search query or contact display algorithms stored in a memory location.

In another aspect, the present disclosure provides a method for soliciting an evaluation from a user of a strength of at least one tie between contacts, comprising (a) on a user interface of an electronic device of a user, displaying contact information of a contact of the user, wherein the contact information includes a name and/or imager of the contact, and a series of categories into which the contact is classifiable by the user, which categories are indicative of different strengths of a relationship between the user and the contact; (b) receiving input from the user on the user interface to categorize the contact in a given category among the categories, which given category has a tie strength evaluation score that is indicative of a strength of the relationship between the user and the contact; and (c) recording the tie strength evaluation score in computer memory.

In some embodiments, the method further comprises executing with a computer processor a strength algorithm to generate a predicted strength of a relationship between the user and the contact prior to (b), and presenting the predicted strength of the relationship to the user on the user interface. In some embodiments, (b) comprises receiving a tie strength evaluation score of the contact from the user. In some embodiments, the method further comprises inputting the tie strength evaluation score into search query or contact display algorithms. In some embodiments, the method further comprises ordering a display of contacts to be evaluated by the user, and further, the contacts may be presented with predicted strengths of relationships to the user.

In an additional aspect, the present disclosure provides a method for computing a relative strength of at least one path of relationships between contacts that are embedded in a network of contacts as direct contacts or indirectly through at least one path of relationships, comprising (a) receiving an input of at least two contacts from one or more databases or lists of contact information; (b) determining the at least one path of relationships that indirectly connect the two contacts using information from multiple sources, wherein at least one of the multiple sources is a social network; (c) assigning with a computer processor a discrete or continuous score to describe a strength of a path(s) of one or more relationships between the two contacts, wherein the score is determined by artificial intelligence algorithms and/or machine learning algorithms stored in a memory location and implemented upon execution by the computer processor, which algorithms incorporate predictive features describing (i) characteristics of users, including at least one of the two contacts, (ii) characteristics of relationships between the users, (iii) characteristics of networks that connect the users, (iv) activities of the users or activities that characterize relationships between the users, (v) strength scores, and/or (vi) other characterizations of a strength of a user's relationship to another user that have been manually or automatically entered by the users; and (d) inputting the score into search query or a contact display algorithms stored in a memory location.

In some embodiments, the information from multiple sources in (b) comprises a ranking of an intermediary connection between the at least two contacts received from a first contact of the at least two contacts, and in further embodiments, the information from multiple sources in (b) comprises a ranking of an intermediary connection between the at least two contacts received from a second contact of the at least two contacts. In some embodiments, the method further comprises ordering a display of paths that have been evaluated by the search query or contact display algorithm. In some embodiments, the path is presented with characteristics provided in (c).

In an aspect, the present disclosure provides a computer system for displaying contact information, comprising a computer processor that is programmed to access a contacts database and retrieve contact information based on a search query inputted by a user; and an electronic display coupled to the computer processor, wherein the electronic display includes a user interface that displays contact cards comprising contact information retrieved from the contact database upon the search, wherein the contact information is ordered on an individual contact card based upon contextual information of the user.

In some embodiments, the contextual information comprises a geographic location of the user. In some embodiments, the search query is inputted by the user in the user interface. In some embodiments, the contextual information comprises an amount of communication between the user and a contact of the user. In some embodiments, the contextual information comprises an age of the user. In some embodiments, the contextual information comprises a company associated with the user.

Another aspect of the present disclosure provides a computer readable medium with machine executable code that upon execution by one or more computer processors implements any of the methods above or elsewhere herein.

Another aspect of the present disclosure provides a computer system (e.g., a mobile device) comprising one or more computer processors and computer memory. The computer memory comprises machine executable code that upon execution by the one or more computer processors implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a computer system that leverages a variety of data sources to develop a picture of a user's network of contacts;

FIG. 2 is a screenshot of a user interface showing the system connecting the local device contacts and calendar with contacts downloaded from Facebook®;

FIG. 3 is a screenshot of a user interface showing the system connecting email services and LinkedIn® to download contacts and communication history;

FIG. 4 schematically illustrates local contact resolution;

FIGS. 5A-5B schematically illustrate global identity resolution;

FIG. 6 is a workflow for guided search of contacts;

FIG. 7 is a screenshot of a user interface, on an electronic device of a user, which displays example results of an efficient guided search;

FIG. 8 is another screenshot of a user interface, on an electronic device of a user, which displays example results of an efficient guided search;

FIG. 9A shows example context notes that can be generated by a user. FIG. 9B shows an example workflow in which a user adds a contact and subsequently adds context notes to the contact;

FIGS. 10A-10B are screenshots with example profiles of contacts;

FIG. 11 schematically illustrates an approach that a system of the present disclosure may implement to determine the tie strength between user A and user B;

FIG. 12 is a screenshot of a user interface that shows the disposition of a contact (Brian Sullivan) with respect to a user;

FIG. 13 schematically illustrates social clusters;

FIG. 14 schematically illustrates the path strength between a user and a potential contact;

FIG. 15 shows two contact lists;

FIG. 16A schematically illustrates connections between user A and contact B, and contact B and contact C; FIG. 16B is a screenshot that shows the system suggesting contacts to the user;

FIGS. 17A-17B are screenshots of a user interface showing a user performing a reverse electronic mail (email) lookup (or search) for a potential contact;

FIG. 18 is a screenshot that shows which contacts of a user are in a common city;

FIGS. 19A-19B are screenshots of location-based social discovery;

FIGS. 20A-20B are screenshots of example contact cards; FIG. 20C is a screenshot of a user interface (UI) that shows a contact card with multiple contacts;

FIG. 21A is a screenshot of a contact card that shows information of a given contact of a user; FIG. 21B shows a Favorites list of the user;

FIG. 22 schematically illustrates an algorithm for local identity resolution;

FIG. 23 schematically illustrates an algorithm for GlobalID generation;

FIG. 24 schematically illustrates an algorithm for global identity resolution;

FIG. 25 schematically illustrates an algorithm for contact aggregation from various sources;

FIG. 26 is a screenshot of a main interface of an application (“app”);

FIG. 27A is a screenshot that shows an example “lives-in card”; FIG. 27B is a screenshot that shows an example “visiting card”;

FIG. 28 is a screenshot of a “meeting card” with relevant information about an upcoming event;

FIG. 29A is a screenshot of a favorites tab of an application; FIG. 29B is a screenshot highlighting a ‘quick-call-text’ feature of an application;

FIG. 30 is a screenshot showing search results ordered by relative importance of the contacts and giving contextually relevant information about each result;

FIG. 31 is a screenshot of a “history card” shown in contact profiles; and

FIG. 32 schematically shows a computer system that is programmed or otherwise configured to implemented methods of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “contact,” as used herein, generally refers to an individual or entity (e.g., organization or company) that has contact information as well as other attributes, such as, without limitation, tie strength(s) and strong mutual connection(s).

The term “secondary contact,” as used herein, general refers to a contact of a contact of a user. More particularly, the term “secondary contact” may refer to a contact of a contact of a user where the contact of the contact is not primarily connected to the user and may also be referred to as a second-degree contact.

The term “contact information,” as used herein, generally refers to any identifying information of a user or entity, such as, without limitation, name, telephone (“phone”) number, fax number, electronic mail (“email”) address, social network identification (“social network ID”), instant messaging (“IM”) handle, and/or identifying addresses for other communication or content sharing services.

The term “identity,” as used herein, generally refers to any identifying information of or related to a user or contact of a user, such as one or more of name (first and/or last name), address (street address, city, state, zip code), phone number, social network ID, email address and IM handle.

### Contact Management Systems and Methods

The present disclosure provides methods and systems for storing contact information locally on an electronic device of a user (client) and revising, editing, or otherwise managing the contact information using the electronic device of the user. In some cases, this is performed without the direct use of a central computer server, which, for example, advantageously provides for improved performance and helps protect a privacy of the user.

The present disclosure also provides methods and systems for storing contact information in a distributed fashion across electronic devices of users. In some cases, such contact information can be revised, edited or otherwise managed in a distributed fashion that may be informed by the consensus of users on the network.

An aspect of the present disclosure provides systems and methods that enable a user to search for, manage and update contacts, including contact information. In some embodiments, a contact management system comprises a computer system (see below) that maintains contact information from one or multiple sources, such as a contacts database stored on an electronic device of a user and a contacts database provided by a social network provider. The system can aggregate and harmonize the contact information in a single database, which may be maintained locally on the electronic device of the user (e.g., mobile electronic device). The system can then update the contact information based on changes to the contact information (e.g., changed phone number or email address), or based on changes in the relationship between the user and a given contact. Such update may be made with little or no involvement from the user.

In some embodiments, the system stores and sorts information in a database using indexes that allow a user to automatically search for contacts or other information given any string, such as identifying information or notes about a contact. Such string can be, for example, a name, address, title, time frame, institution name, keyword, contact history, note, relationship to other contacts, or verb (e.g., Met, studied, worked, etc.) and may be a synonym, nickname, substring, or short form of any of the above. The database can store disparate types of objects. The search function can use multiple layers for searching, including a natural language layer, a generic search layer, and an index that facilitates the search layer. The index can permit the system to suggest contacts based on the string entered by the user. Such suggestion can be, for example, contacts that may have a given relational separation with the user (e.g., first degree, second degree, . . . , nth degree) in a given location (e.g., company or geographic location) that at least partially matches the string, or one or more contacts that at least partially match the string and may have the given relational separation with the user.

In some situations, the system contextually orders contacts. Such contextual ordering can be based on work, social, educational, entertainment, geographic, and/or temporal context. For example, contacts of the user that are located in a geographic area of interest to the user (e.g., as entered in a search) or a geographic area visited by the user (e.g., as may be determined by a geolocation device of the user) may be brought to the top of a list of contacts, or otherwise prioritized over other contacts. In an example, when the user is visiting San Francisco, Calif., the system may bring contacts of the user that live in or near San Francisco to the top of a list of contacts of the user. This ordering may be contextual and dynamic, for example, and without limitation, if the relevance of contacts changes with the time of day or day of week during which the system is triggered.

The system allows a user to find the closest contact (that is, the contact with the highest tie strength between the user and that contact) that matches a given search criteria. In some situations, the connection between a user and a potential contact (e.g., a second-degree connection) may be elevated if the user has a strong mutually shared connection with that potential contact. Relationship strength and contact relevance can be similarly informed by other aspects of social network topology that may be derived from the local database of the user or a global, server-managed network.

The system can provide a user the ability to discover all shared connections with a potential contact across various contexts (e.g., Shared friends, colleges, employers, locations, etc.) via a reverse number (or email) lookup, match to a contact, and then identify a path to the user (provided there is a strong connection pathway to that potential contact).

The system can determine the relational strength between a user and a potential contact based on observed interactions between the user and shared connections with the potential contact (e.g., email interaction, social network interaction, etc.), as well as the strength of a relationship based on past shared experiences (e.g., locations, colleges, or work), shared interests, shared contacts, the structure of the network connecting the contacts and other information.

Utilizing these aspects, information related to the contacts of the user includes not only information about the contacts, but also about the source of the information. For example, information related to the contacts of the user may include the source of the contact information (e.g., manual input, public records, or a particular social network such as Facebook®, LinkedIn®, etc.). Additionally, the system may also store accessing information to these sources of information, such as a social networking password one or more of a user's social networks. In this way, the contact management system may not only search for, manage and update contacts that have been entered into the contact list of the user, but the contact management system may also perform reverse look-ups and contact associations across networks, such as Facebook® or LinkedIn®, based on shared contact information.

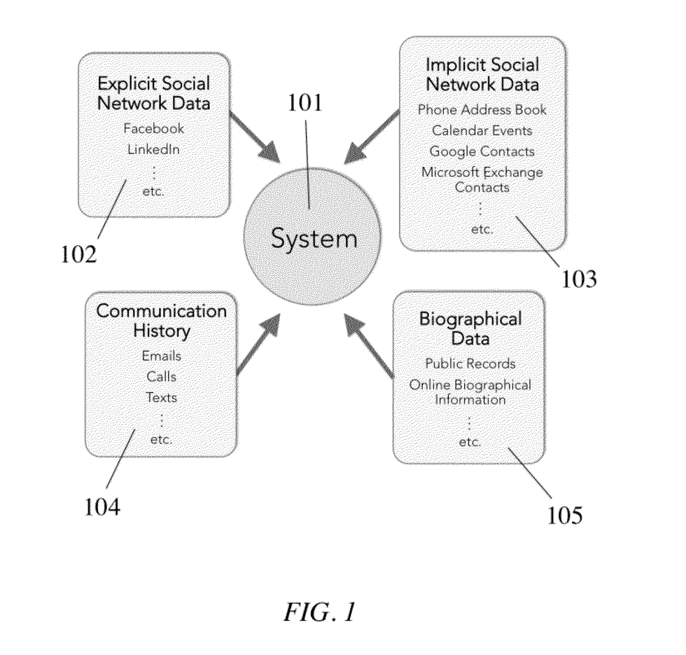

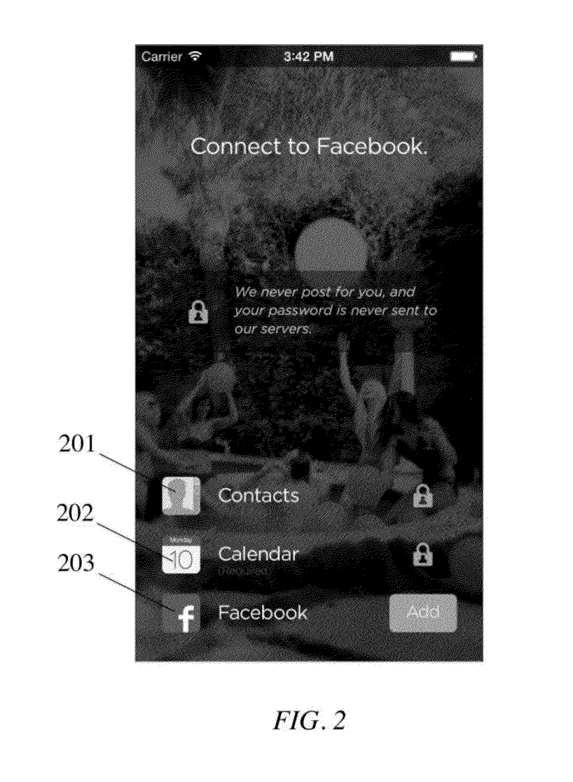

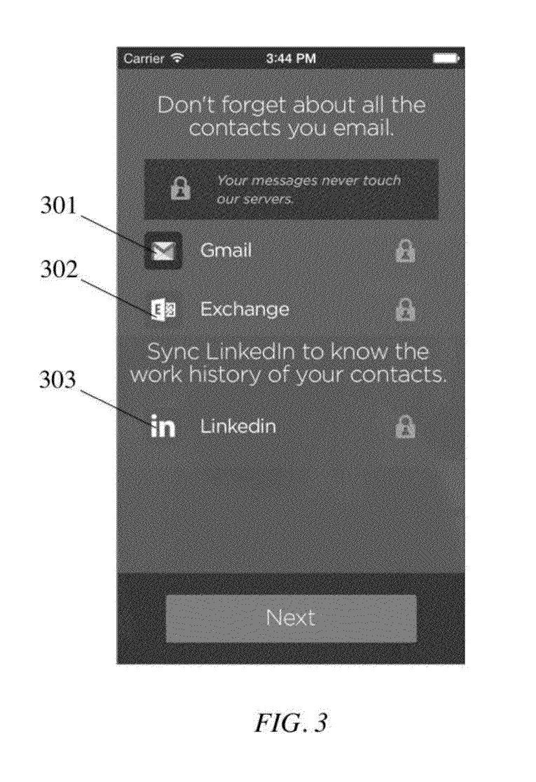

FIG. 1 shows a computer system 101 that leverages a variety of data sources to develop a picture of a user's network of contacts. The system 101 can be an electronic device of the user. As an alternative, the system 101 can be a computer server or multiple computer servers. A computer server can have one or more computer processors and memory, as described elsewhere herein. The system 101 can aggregate data from itself or other sources, such as explicit social networks 102 (e.g., Facebook®, Google+®, LinkedIn®, etc.), implicit social networks 103 (e.g., email contacts, calendar events, electronic address books, etc.), communication history 104 (e.g., emails, phone calls, text messages, etc.), and other sources of biographical data 105 (e.g., public records, etc.). The system 101 can aggregate a picture, uniform resource locator (URL), relationships information, and user or contact history, such as work history, education history. In some embodiments, the system 101 does not aggregate private information (e.g., phone number or email). This enables the system 101 to synthesize a single composite network of contacts that includes friends, family and professional connections. The system 101 can access an explicit social network 102 to retrieve contact information. For example, the system 101 make a request to Facebook® to access contacts 203 of a user and import the contacts, as shown in FIG. 2, or log onto LinkedIn® to access contacts 303 of the user, as shown in FIG. 3.

Contacts can be generated and saved in profiles on an electronic device of a user, a system (or server) that manages contacts, or both. In an example, a mobile electronic device may have a database of contact records. The database can include one or more contact records. A contact record can belong to a distinct individual. Additionally, one individual may have multiple contact records. Further, a contact record may comprise at least one or a plurality of contact information.

Contacts can also be displayed on a user interface of the electronic device of a user, such as a graphical user interface (GUI). The GUI may be personalized to the user, having nodes connecting contacts of the user. In some examples, the nodes presented on the GUI are stored based on queries that connect the contacts. Additionally, the GUI may be personalized based on display preferences of the user. The GUI may also be based on the context that is chosen by the user. Further, contacts can be displayed as contact profiles, which can include the contact information, communication history, relationship context, biographical data and mutually shared connections of a given contact (see below).

The system can present contacts to the user through an application (“app”) that is executed on the electronic device of the user. The app can contact the system to retrieve contact information, enable the user to input contact information, or otherwise enable the user to manage contacts. Additionally, the app can retrieve contact information from external sources. For example, the app can utilize periodically expiring access tokens associated with a user's social networking accounts to query the social networks for additional information associated with the user's contacts. This allows the app to acquire information that is useful to the user while not storing the sensitive passwords of the user to prevent any security risk associated with preserving that information. In an example, the app may connect to a user's Facebook® account using the user-specific Facebook® token, and may identify new contact information (e.g., updated contact information for current contacts of the user, or new contacts associated with the user who have recently joined Facebook®).

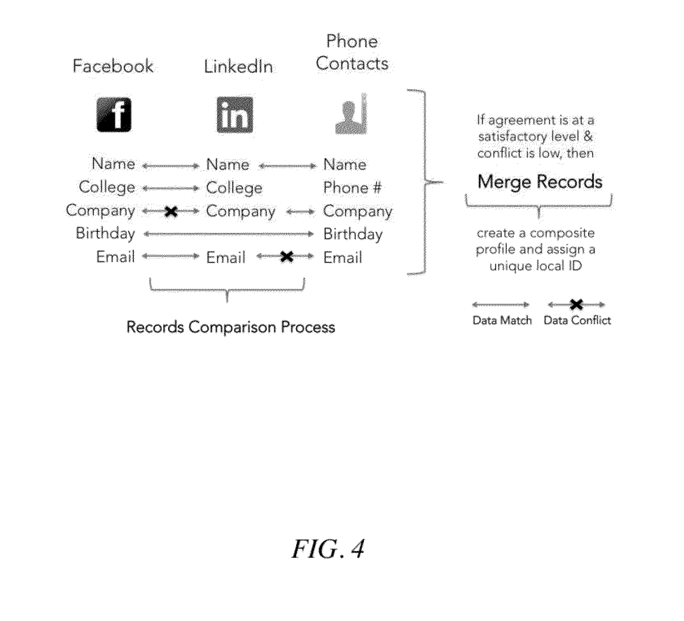

The system can enable contact resolution. With reference to FIG. 4, while the system aggregates contact information from multiple sources, contact records (or contacts) that relate to the same identity may need to be identified and merged into a single profile, even though the records may contain different names for that person or different attributes. For example, a graphical user interface having different identities from different sources (e.g. manual input, public records, or social network accounts) may have identifying information of seemingly different contacts merged into a single, consolidated contact record when it is determined that different identities belong to the same individual or group of individuals. A consolidated contact record may be generated based on a request from a user. In particular, the consolidated contact record may be formed by merging contacting information. For example, the consolidated contact record may include at least a portion of contact information that overlaps between contacts. However, even if there is no overlap, a user may choose to not merge the information. As such, the user may choose to not generate a consolidated contact record based on overlapping contact information.

For example, when a phone number is entered as an identifying piece of information associated with a person or group of people, the system may perform a look-up and return information associated with each separate identity that is listed as being in association with that phone number. So the server may determine that the phone number is associated with three contacts, “Joe Brown,” “Joseph Brown,” and “Joey Brown.” Accordingly, in response to the phone number query, the system may return a Facebook® profile of Joe Brown, a public record of Joseph Brown, and a manual input identity for “Joey Brown” that was input by the user.

In addition to just providing these three accounts associated with a given phone number, the system may determine that the three identities are associated with the same person, who the system may generally refer to as “Joseph Brown.” This determination that identities are associated with the same person may be based on commonalities between the three accounts. Further, when determining whether different identities are related, the system may take into account constraints that override or lessen the likelihood that the identities are directed to a single individual. For example, the system may use the similarity of names in the “Joseph Brown” example to indicate that the three accounts belong to the same name. However, the system may have another constraint that indicates listed associations between identities overrides the system's assumed relationships. So if the Facebook® profile of Joe Brown lists that he is best friends with a “Joey Brown,” the system may determine that this characterization is enough to keep the Facebook® profile of Joe Brown from the manual input of the contact Joey Brown. Alternatively, the system may undergo further analysis, such as analyzing birthdays for the Facebook® profile of Joe Brown and the manual input of Joey Brown so as to confirm that the two identities are distinct.

Accordingly, the system may map identities, such as the three identities associated with “Joseph Brown,” based on verbal queues. For example, the system may map the three identities associated with “Joseph Brown” on a graphical user interface. The system may also return contact information that is stored on, or accessibly by, the system associated with the merged contact “Joseph Brown.” For instance, the system may return identity attributes and contextual relationships associated with all three of the accounts associated with “Joseph Brown,” including relationships between the identified Joseph Browns. For example, the system may recognize that the “Joe Brown” identity on Facebook® commonly receives comments from identified parental identities that refer to him as “Joey,” which increases the common information between “Joe Brown” on Facebook® and “Joey Brown” as manually input by the user. As such, the system may augment the amount of information that would be known based on the three identities as viewed separately, and may utilize the information stored on, and accessible to, the system so as to provide a more complex, merged identity of the searched “Joseph Brown.” Further, while examples discussed provide identity results of contacts as analyzed by the server based on information stored on or accessible to the server, other examples may provide identity results of contacts as analyzed at the electronic device of the user. In these embodiments, the identity results of the contacts may be analyzed by processors on the electronic device based on information stored on, or made accessible to, the electronic device (e.g., as accessible to an app running on the electronic device).

The system can include a local identity resolution engine that determines which records represent the same individual. The engine can be part of an application that is executed by the engine to perform local identity resolution. The system works while the information is gathered on the electronic device of the user. This engine can format the incoming data into common profiles whose fields can be compared to gauge the level of agreement and/or disagreement between two or more records. If the agreement is above a certain threshold (e.g., greater than 60% agreement—although this threshold may differ between users) and there are no blocking disagreements, the records are merged to form a new composite profile that can be matched against any additional records that pass through the identity resolution engine. Negative signals, such as information based on constraints, can indicate that the incoming data is associated with two or more contacts, which can be used to generate two or more profiles. If data provides signals that a current profile should be split into multiple distinct profiles, the record is split to form two new distinct profiles that can be matched against any additional records that pass through the identity resolution engine. The engine can function with a new set of records from various sources (e.g., Facebook®, LinkedIn®, address book or email), an incremental set of records from an existing source (e.g., Facebook®, LinkedIn®, address book or email), and a new source with records that have not been processed (e.g., Salesforce® records).

By design, this engine is able resolve identity in a time period that is linearly proportional to the number of contact records that it processes. The engine is efficient enough that it can be executed by a computer process on an electronic device of the user, such as, for example, a smart phone (e.g., iPhone® or Android® enabled phone) or tablet personal computer (e.g., Apple® iPad or Samsung® Galaxy Tab), as opposed to sending all of the data to a central server for processing.

The engine can take into consideration the contact's name in the profile in addition to attributes of the contact (e.g., email, phone number, mutual friends with the user, work, education history, birth date, etc.) and allows for identification of phonebook entries under nicknames, such as, for example, entries like ‘Mom’ or ‘Dad’ can be matched with a Facebook® record that shares a last name and is marked as the parent of the user.

In global identity resolution, the system can also leverage information contributed by multiple users to improve identity resolution. In some examples, the information contributed by multiple users is input, and potentially verified (discussed below), at the electronic device of the user prior to providing the information to a server. In this way, the each user's view of the relationships between contacts may be unique to the user. Additionally, each user has control over how her view of the relationships between contacts ultimately is represented in the user's unique perspective of relationships. For example, if an event occurs, such as a contact moving from San Francisco, Calif. to Seattle, Wash., the user may be notified to update her contact information for that contact. However, the user may still choose to associate that contact with San Francisco, Calif., even in light of the notification that the contact actually changed residences. Alternatively, the user may establish rules that allow automatic updates to contact information, or portions of contact information (e.g. only phone, or only phone and email) associated with the users' contacts. As such, each user's view of his contacts may be personalized. Once updates are made to the user's personalized view, such as on the user's electronic device, the updates may be sent to a centralized server to combine data from other users. This distributed infrastructure is enabled by faster user electronic devices.

Additionally, the rank of contacts may be personalized to the user. For example, if a search engine returns search results of contacts based on a user query, the search results may be contextualized based on the user's ranking of contacts. In this way, the page rank of search results may be affected by the user's ranking of contacts and/or the user's prioritization of contextual information. Further, the user's chosen priorities may themselves be based upon context. For instance, the system may recognize that when a user is searching for a dinner companion, geographic location of the user's contacts may be the highest contextual priority for searching and/or ordering returned search results. In other example, however, when the user is searching for someone to talk to, the extent of communication history between the user and the user's contacts may be the highest contextual priority for searching and/or ordering returned search results.

### Harmonizing Contact Information

Methods of the present disclosure can allow a user to generate a coherent list of contacts from multiple and in some cases disparate source of contact information. In particular, the generation of contacts as described herein combines, harmonizes, and augments information that may otherwise not be readily available. For example, contact information that is provided from a user can be assessed against a global database of contacts to ensure that the contact is unique. In particular, the database may comprise contact records. Additionally, if the contact is not unique, the system may return to the user auxiliary information associated with the contact based on information stored at, or accessible to, the server in association with the contact.

As an example, after the local identity resolution engine has finished processing on an electronic device of the user (e.g., phone), a server system can perform GlobalID generation, in which de-duplicated records with unique local identification (IDs) are compared to a global database of contacts using a process called Candidate discovery. If Candidate discovery does not find any existing profile in the global database, the system generates a unique global ID and returns it to the electronic device of the user. If Candidate discovery does find a single record in the global database, the existing global ID associated with the matched profile is returned to the electronic device and no new global ID is generated.

In some cases, an abundance of information associated with the record containing a global ID may indicate that the global ID is associated with multiple contacts stored on the user's electronic device. For example, information associated with the global ID may include aliases or pennames associated with a contact. In such situations, it is possible that the user may not know that two seemingly distinct contacts are actually the person. As such, assessing the returned global ID against seemingly disparate contacts of the user may result in the same global ID being returned for more than one local ID on a user's electronic device. Based on the new information, this may override the initial local identity resolution process and merge the information of local records that share the same global ID on any device containing that global ID.

In some situations, new data sent to the system from the user can also trigger the merger of global profiles. For example, if a local record sent to GlobalID generation maps to multiple global records without conflict (via Candidate discovery), a new global ID is generated to represent the composite of the two pre-existing global profiles, thereby associating the two seemingly disparate identities with one contact. This new global ID can be sent to the user's device and also propagated to all the other electronic devices where the application references any of the affected global IDs. This harmonizing of information may be performed at a server of the system. Alternatively, harmonizing may occur at the electronic device of a user, particularly when merging information that links two or more contacts is received or input by the user. Further, even when harmonizing is performed at server of the system, the system may first look at the information stored on the electronic device of the user.

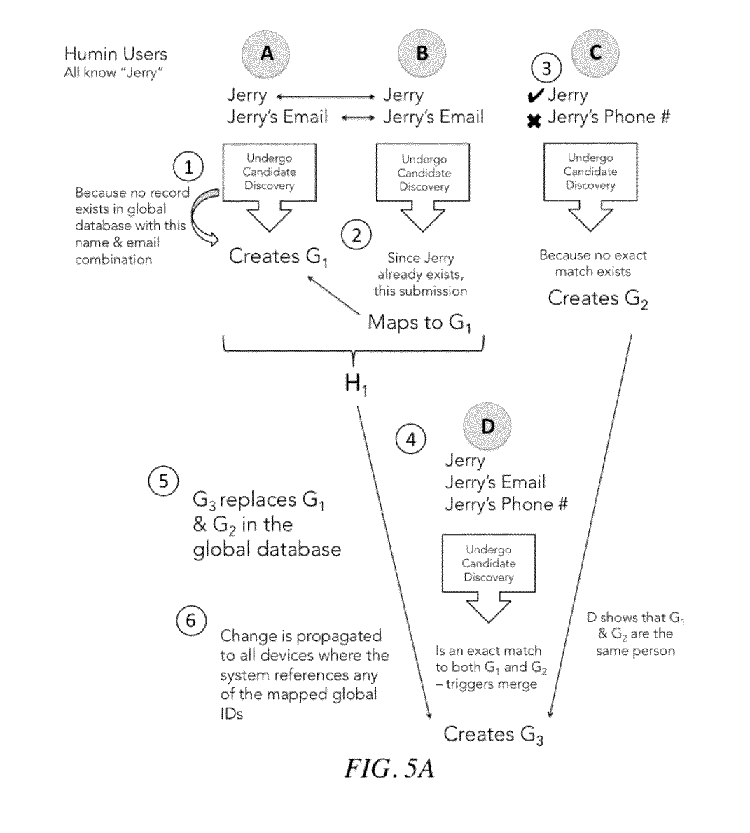

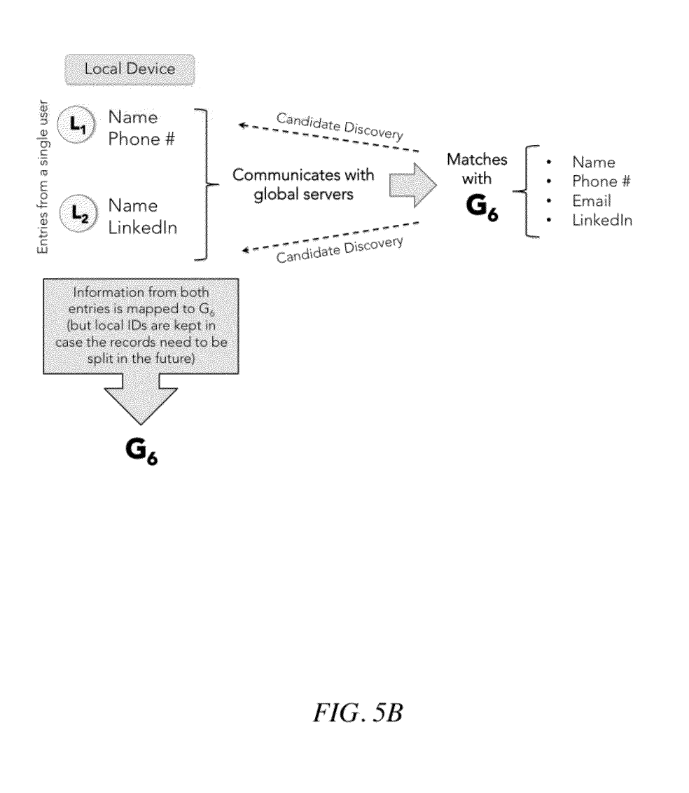

In an example of linking information associate with a contact, and with reference to FIG. 5A, the system resolves contact “Jerry” across three users, A, B and C. In GlobalID generation, the system compares the contact information of Jerry (e.g., name and email address) to the information of contacts available on the system. If the system does not find a match, then the system creates a new contact (G1) and associates a global ID with G1. In this event, the contact information of Jerry as known to user B is then compared to Jerry's contact information as retrieved from user A. When comparing the contact information of Jerry that is provided from user A and user B, the system may determine that there is a match between Jerry's name and email address. Accordingly, Jerry's contact information as provided by user B may be mapped to the contact information for Jerry that is retrieved from user A (G1). Further, for user C, the system may compare the contact information associated with Jerry from users A and B against the contact information for Jerry that is retrieved from user C. However, based on this comparison the system may determine that the contact information for Jerry, a phone number, does not match any phone number on the system. Accordingly, the system may create a new contact (G2) and may associate Jerry's phone number with the new contact G2.

However, when a fourth user, user D, introduces a record with both Jerry's name, phone, and email, the system may recognize that this information matches both G1 and G2. In this event, the system may compare G1 and G2 and determine that they represent the same contact (Jerry). As such, the system may subsequently create a new contact (G3) associated with Jerry. In particular, new contact G3 may merge all information from G1 and G2. This new ID (G3) may then be propagated to all devices where the system references G1 or G2. In these devices, the previous references to G1 and/or G2 may be replaced with the augmented contact G3. In particular, a user may implement automatic updates for merging such contacts, or a user interface (UI) design may be provided to illustrate to the user that he has the option to combine references G1 and G2 into one integrated contact.

Upon reviewing the option, the user may choose to keep references G1 and G2 as separate contact. In particular, while the GlobalID may have accurately assessed contacts G1 and G2 as being associated with the same person, the user may wish to have contacts G1 and G2 kept separate as contact G1 may be associated with work matters while contact G2 may be associated with personal matters, even though contact G1 and contact G2 are determined to be the same person. In this way, the user may control and manage the unique relationships associated with a single individual.

Another example of harmonizing two contact entries on the electronic device of a user is provided in FIG. 5B. In FIG. 5B, two contact entries may be sent from the user to the server. In particular, the two contact entries “L1” and “L2” may seem distinct when assessed against the users' localized identity reconciliation based on information stored at the user's electronic device. However, when entries L1 and L2 are received at the system, they may be assessed against the system's Global ID assessment and generation process (as referred to in FIG. 5A). Based on the Global ID assessment, the system may determine that the entries L1 and L2 are matched with a contact G6. In particular, contact G6 may include the name, phone number, email and LinkedIn® profile link of the contact. In some examples, the information that the system has associated with contact G6 may be greater than the combined information that was previously known to the user. When the system has permission to provide some or all of this extra information to the user, the system may direct this information of contact G6 to the electronic device of the user as the global ID for L1 and L2, thereby merging the two records on the local device. Even in cases where the system does not have permission to provide any further information about G6 to the user (e.g., due to privacy concerns), the system may still return the global ID for G6 to the user so that the user is able to merge entries L1 and L2. Additionally, while examples discussed herein describe the use of a GlobalID to assess and identify unique contacts of the user, a GlobalID may also be used to assess and identify unique data of other types as well. For example, a GlobalID may be used to merge seemingly disparate descriptions of locations into one centralized location. As such, the of GlobalID generation may be applied to other data stored on, or accessible by, the system.

The system is automatically configured for efficient searching, including guided searching. The system can enable the user to perform various social search queries in a natural language (e.g., “lives in . . . ”, “worked at . . . ”, “met at . . . ”, “first met last night”, “met last week”, “friends with . . . ”, “studies at . . . ”, etc.). For each character inputted by the user, the system refreshes (e.g., on a user interface of the user) a list of the most likely guided searches as well as showing the profile pictures of the top results matching the current string. This can be enabled by a unique search index that is built using the local database on the user's electronic device. In this way, a user's search index may be personalized, such as by mapping the user's contextual relationship to contacts and/or object. This along with natural language engine makes the system not just fast and easy to use, but also available when a user is offline.

This index matches varying names of contacts (e.g., first, last, middle and nicknames—there may be multiple names for the same identity) and attributes of the contacts (e.g., gender, relationship status, etc.), other objects that the contacts are related to (e.g., addresses, phone numbers, emails, work history, school history, etc.), attributes of those relationships (e.g., work roles, college majors, etc.), and temporal information for any of the above.

In addition to providing methods of merging identities based on common information, the system may also allow users to split identities of contacts. For example, a user may choose to split their information associated with a work colleague into a work-based identity (e.g., “Sandy Work”) and a personal-based identity (“Sandy Home”). In this way, the user may intentionally split information associated with a particular person so as to help the user to communicate appropriately via the different forms of communications available to her. Additionally, the system may provide a user interface (UI) design to aid the user in splitting a contact without having to remember phone numbers and email addresses of the contact prior to splitting. For instance, a UI design may be provided where contact information associated with different aspects of a contact's life is summarized as “Sandy home phone number” and “Sandy work phone number” rather than just stating the different phone numbers and expecting the user to know which phone number is associated with each area of Sandy's relationship (e.g., personal or work) with the user. Alternatively, a UI design may be provided to allow a user to split contact information associated with a contact based on the source of the contact information. For instance, the UI design may give the user an option to associate information related to a social network to a “Sandy Home” contact. Similarly, the UI design may give the user an option to associate information and communications related to a work email address to a “Sandy Work” contact.

As such, the user may provide information associated with Sandy's work identity (e.g. work phone, work email) and may interact with this identity when the user has a work-related question. Similarly, the user may provide information associated with Sandy's personal identity (e.g. home phone, personal email) and may interact with this identity when the user has a personal-related communication. For example, the user may send a party invitation to her “Sandy Home” identity for the contact, whereas the user may send a lunch meeting invitation to her “Sandy Work” identity for the contact. In examples, the mergers and splits of identities may be user-initiated or may be initiated by the server. If a merger or split of identities is initiated by the server, the action may be implemented once the action is confirmed by the user.

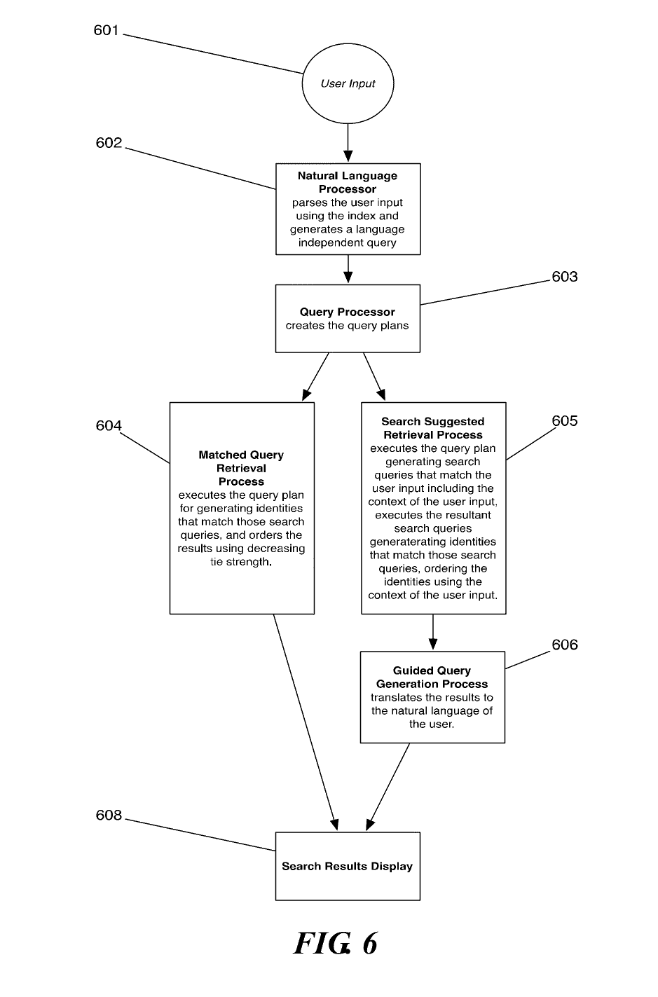

The app may enable a user to perform both structured and unstructured queries on their aggregated contacts. An example of an unstructured search may comprise querying a single keyword that may be found in any field associated with a contact, whereas a structured search may use a guided query process to efficiently parse user intent. FIG. 6 is a workflow for guided search. In a first operation 601, the system receives user input 601, which is directed to a natural language processor 602. The natural language parser may parse the user input 601 using the user's natural language, using adaptive grammar rules, and/or using the index. Additionally, the natural language processor may search within words or phrases to identify query information. For instance, the natural language processor may search “North” based on its presence in the query “University of North Carolina.” Based on the parsing of the user input 601, the system may generate a language independent query structure. The language independent query structure may be easily translated into one or more languages. Additionally, the system may pass the language independent query structure to the query processor 603. The query processor 603 then creates the query plans and directs them to both the Matched Query Retrieval process 604 and the Search Suggested Retrieval process 605. The Matched Query Retrieval process 604 executes the query plan for generating identities that match the user input 601 and then orders the results using decreasing tie strength.

The Search Suggested Retrieval process 605 executes the query plan for generating search queries that match the user input 601 including the context of the user input 601. Examples of context that may be utilized in searching and/or ordering contacts of the user include geographic area hierarchies; entity hierarchies; role hierarchies; searching within terms; searching identifying aspects of the contact (e.g, is the contact a person or an institution), and searching based on interactions of the user.

An example of geographic area hierarchy includes giving a preference in searching for contacts that are within the user's current geographic area. Another example of geographic area hierarchy includes giving a preference in searching to contacts that are within a user's geographic area of interest (e.g., as determined by having the user query, “Who do I know in London?”). Additionally, search results may be influenced based on locations that are inferred for the user. For example, if a user has provided contextual information that the user will be visiting Paris during a certain period. Additionally, a user interface (ID) may be provided to the user to indicate the geographic location of contacts from search results on a map.

An example of an entity hierarchy includes giving a preference in searching for contacts that are within an entity associated with the user (e.g., for contacts who work for the same company as the user). Another example of an entity hierarchy includes giving a preference in searching to contacts that are within the user's entity of interest (e.g., who do I know who works at a bike shop?). Similarly, an example of a role hierarchy includes giving a preference in searching to contacts that share the same role as the user (e.g., residents in a medical program). Another example of a role hierarchy includes giving a preference in searching to contacts that are within the user's area of interest (e.g., teachers at a particular school).

The Search Suggested Retrieval process 601 may also give preference in searching to institutions rather than contacts based on the search query. For instance, if a user searches for “colleges in the Northwest,” the Search Suggested Retrieval process 601 may give a preference in searching to institutions, or at least to entities having the terms “College, University, Technology School, etc. in their names or descriptions.

Additionally, the Search Suggested Retrieval process 601 may give a preference in searching based on the context of communications and/or meetings. For example, if a user inputs a query for “Met last Wednesday,” the Search Suggested Retrieval process 601 may check the contacts who the user had a meeting with on the prior Wednesday and may give preference to those contacts in searching. In this way, the context of the search may be personal to the user (e.g., based on the user's personal calendar and/or personal characterization of events).

Such context based on meeting may be based on the date that the user met the contact (e.g., “Met on Jan. 4, 2014”), based on the location where the user met the contact (e.g., met at the Four Seasons), and/or based on the event where the user met the contact (e.g., met at Burning Man). The user may also search within this context based on the user's own characterizations of locations, dates, or other factors. For instance, the user could enter the query for a contact that the user “Met at my favorite museum,” which the server may associated with the San Francisco Museum of Modern Art based on the user's manual input, or rather, based on the frequency at which the user visits that particular museum. In other examples, the Search Suggested Retrieval process 601 may have adjustable context, or learned context, based on the user's past use of the system. For example, the Search Suggested Retrieval process 601 may determine that the user commonly mistakes the month August for October, so the Search Suggested Retrieval process 601 may contextualize queries based on when they query is asked. For instance, if the user inputs a query in September for the contact that he “Met in October,” the Search Suggested Retrieval process 601 may provide potential search results with the confirmation “Did you mean August?” based on the fact that it is potentially more likely that the intent of a search query entered in September is for the server to return a contact that the user met the month previous rather than a contact the user met 11 months previously. Similarly, if the user inputs a query in December for the contact that he “Met in October,” the system may not correct the query given that it is more likely that the intent of the search query entered in December is for the server to return a contact that the user met two months previous rather than four months previous.

Alternatively, the Search Suggested Retrieval process 601 may give a preference in searching to contacts that the user has been in communication with during a threshold period of time (e.g. within the last week, within the last month, within the last year, etc.).

The Search Suggested Retrieval process 601 executes those resultant search queries to generate identities that match those contextualized search queries, and then for each search query orders the identities using the context of the user input 601. In the same or similar way that context may be used to give provide search query results, context may also be used to rank search results that are provided. In particular, the context that is used to rank search results may be personalized based on the relevance of certain contextual details to the user. In some examples, different contexts may be utilized for searching and ordering search results. For instance, geographical context may be used for searching contacts, whereas degree of interaction between the returned contacts and the user may be used for ordering the search results. The Search Suggested Retrieval process 605 then delivers its results to the Guided Query Generator process 606, which translates the results to the natural language of the user. Both the Matched Query Retrieval process 604 and the Guided Query Generator process 606 deliver their results to the Search Results Display 608 which displays the results, for example, on a user interface (UI) of the electronic device of the user.

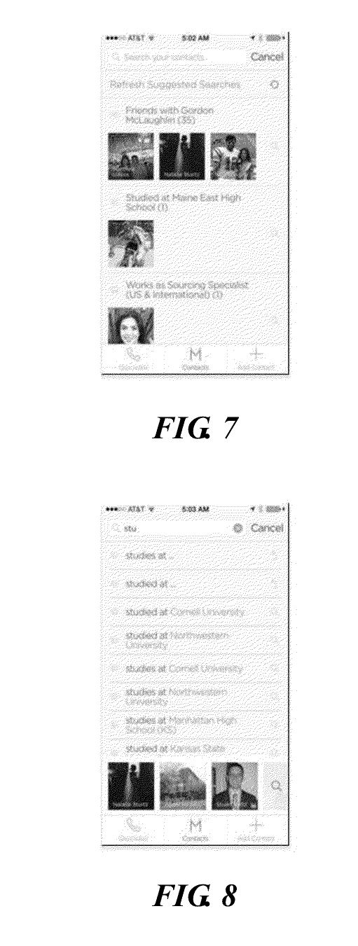

FIGS. 7 and 8 are screenshots of a user interface on an electronic device of a user, which displays example results of an efficient guided search.

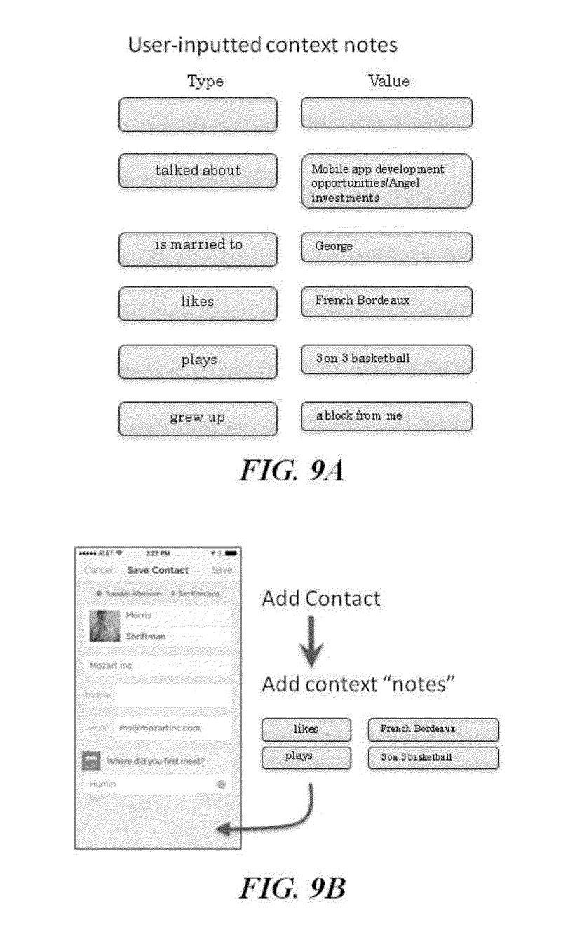

The system can provide users with the ability to define guided search queries through context notes attached to user profiles. A user may use context notes to direct a guided search. Context notes may contain one or more strings with characters, such as words and numbers. FIG. 9A shows examples of various context notes. In an example, with reference to FIG. 9B, a user may add various words to the Notes for a particular contact (e.g., “likes French Bordeaux” and “plays 3 on 3 basketball”). The guided search then permits that user to search for “basketball” and find this contact in the results, or search for “likes French” and find this contact, or simply type “Bo” and find this contact in the list of search results for the suggested query “likes French Bordeaux”

Contacts can be searched and displayed contextually. In some examples, when a user opens the profile of contact A, the user can be presented with a variety of contextually relevant contacts associated with contact A. For example, the system can display mutual contacts shared between the user and contact A, which may be ordered by relevance to the user, such as how well the user knows each shared contact. Such ordering may be based on the social proximity of the user with each mutual contact. For example, mutual contacts that are closer to the user may be ordered higher than other mutual contacts. Such ordering may also be based on the social proximity of the user with each mutual contact or other contextual information. For example, mutual contacts that are work related may be ordered higher than other mutual contacts in the results of a professional search, while mutual contacts that are social or personal may be ordered higher than other mutual contacts in the results of a social or personal search. If the system has the education and work history of contact A, the profile of contact A can display the user's other contacts that attended the same school or worked at the same company, which can also be ordered by relevance to the user.

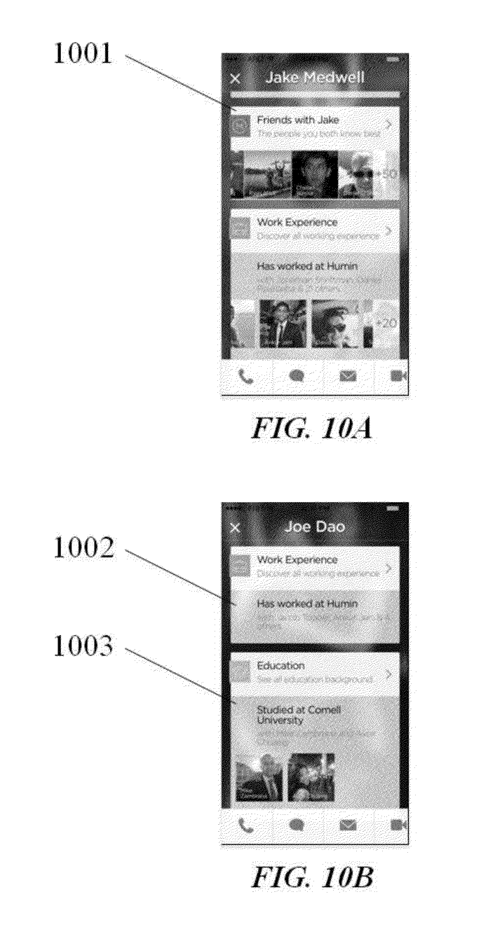

FIGS. 10A-10B are screenshots with example profiles of contacts. In FIG. 10A, the profile of Jake Medwell shows mutual contacts 1001 between the user viewing the profile and Jake Medwell. In FIG. 10B, the profile of Joe Dao shows work information 1002 and educational information 1003 that may be relevant to the user.

In addition to mutual contacts 1001, work information 1002, and educational information 1003, profiles of contacts may also include access to a history of communications between the user and the contact. In particular, a history of communications may provide a user with a single list of communications between the user and the contact independent of the source of the communication. For example, the communication history may include interactions between the user and the contact via phone, text, email, Facebook® message, etc. The types and number of different forms of communication may be limited by the number of communications that the system is able to access. For example, if the user provides the user access to his Facebook® account, the system may provide Facebook® interactions between the user and the contact in the user's communication history with the contact.

The system can estimate the tie strength of relationships between any two identities. This tie strength of relationships can be used to sort or order contacts. The system can aggregate signals or behaviors from social networks, communication history, network effects, and personal histories to estimate the strength of relationships. The system can apply, for example, a five-star rating system that approximates how users view their relationships (e.g., Inner Circle, Close Friends, Friends, Acquaintances, and Strangers). The system can implement a tie strength algorithm that provides any element of granularity. The tie strength algorithm can be implemented on the electronic device of the user.

The tie strength algorithm may be used as a quick rank for providing a list of preferred contacts to the user. However, the user may disagree with the quick rank, and may modify rankings of the contacts, either by highlighting contacts that are generally preferred (and, as such, should receive a higher rank) or by demoting (either by providing a negative indication or by removing a contact from a results list) a contact that is not preferred.

The user can rate relationships with contacts, such as using an application on an electronic device of the user that is coupled to the system. Such rating information can be used by the system to further improve the tie strength algorithm and override estimated tie strength values on the electronic device. Additionally, the system may infer a user's rating of relationships based on other labels that the user provides to contacts. For example, if a user labels a contact “mom,” the system may infer that the tie strength between the user and the contact is stronger than without the label. Additionally, if the user removes a label that would indicate closeness, the system may infer that the tie strength between the user and the contact is less strong than with the label. For example, if a user updates her Facebook® status to remove the information that she is “In a relationship” with a contact, the system may adjust the assessed tie strength between the user and the contact.

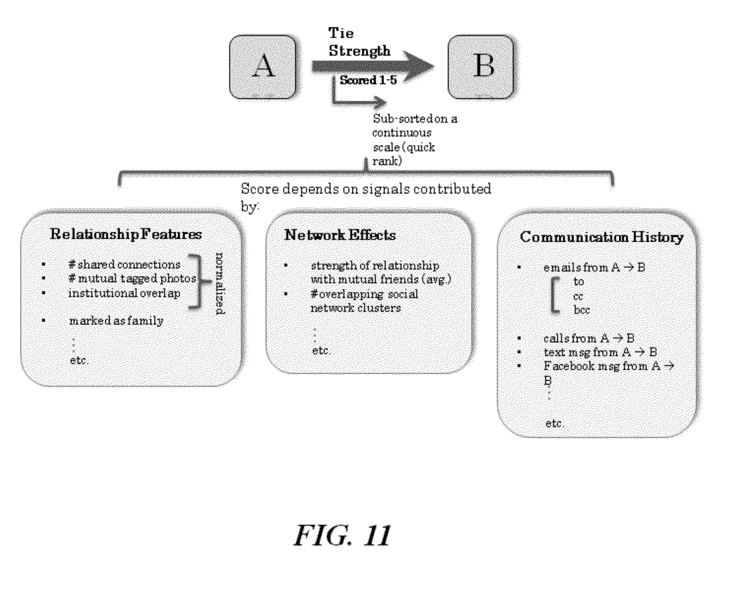

FIG. 11 schematically illustrates an approach that the system may implement to determine the tie strength between user A and user B. The system can rate the tie strength on a scale of one to five, for example. The tie strength between user A and user B can be sub-sorted on a continuous scale. The tie strength can depend on signals contributed from various sources, such as relationship features (e.g., number of mutual contacts), network effects (e.g., strength of relationship with mutual contacts), and communication history (e.g., communications from A to B). The tie strength from A to B may be different than the tie strength from B to A and can vary over time or by context.

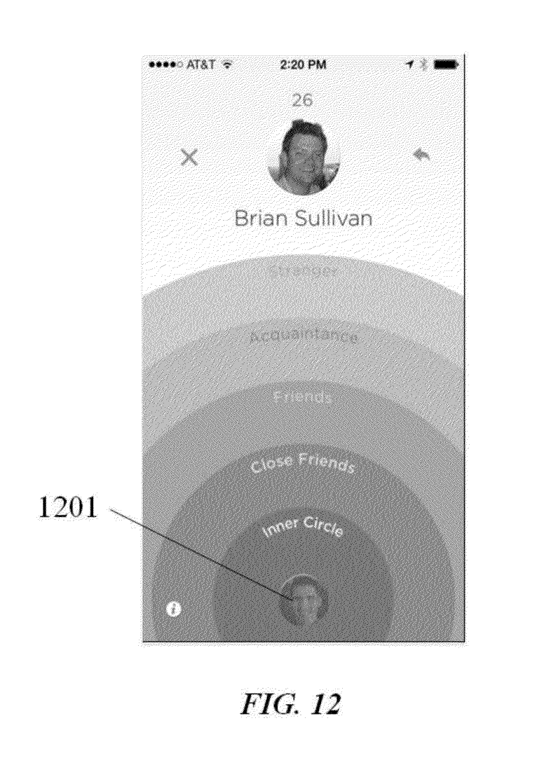

FIG. 12 is a screenshot of a user interface that shows the disposition of a contact (“Brian Sullivan”) with respect to the user 1201. In this example, the contact is in the inner circle of the user 1201. The system can determine that the contact is not in the inner circle but is rather in another circle, such as a close friends, friends, acquaintance, or stranger circle. The disposition can be determined based on the tie strength between the user 1201 and the contact. In some examples, the user 1201 can drag the picture of the contact to within one of the circles to inform (or train) the system as to the disposition of the contact with respect to the user 1201. For example, the user 1201 can drag the picture of the contact to the “Close Friends” circle, enables the user 1201 to help the system determine the tie strength between the user 1201 and the contact.

In addition to assessing the tie strength between the user 1201 and the contact based on the placement of the contact in a given circle of the user, the system may also assess or adjust tie strength based on the placement of the user 1201 in a given circle of the contact. For instance, the user 1201 may place the contact into a circle designated as “Close Friends,” and the system may use this input to assess that the contact and the user 1201 have a reasonably high (e.g., above a threshold level) tie strength. However, the system may also receive an input from the contact that the contact has placed the user 1201 in a circle designated as “Acquaintances,” which the system may assess as having a lower tie strength than “Close Friends.” Accordingly, the system may alter its initial tie strength assessment of the contact within the circle of the user 1201 based on mismatched assessments on the two sides of the relationship. Alternatively, the system may make tie strengths based on the regard of the user 1201 for the contact, where the tie strengths are independent of the regard of the contact for the user 1201. In some examples, the user 1201 may determine preferred inputs in determining tie strength as assessed by the system.

In other examples, tie strength between users may be assessed based on communication patterns. For example, if a user is in frequent contact (e.g., communicates via one or more forms of messaging at least three times a day) with a contact, the system may assess that there is a high tie strength between the user and the contact. However, the system may alter the tie strength between the user and the contact based on responsiveness by the contact. For example, if the user is communicating messages an average of three times a day to the contact, and the contact is not responding, or is responding rarely, the system may lower the assessed tie strength between the user and the contact based on the lack of responsiveness of the contact.

In other examples, the system may contextualize the contact's lack of response by recognizing that the contact rarely responds to any communication, independent of whether the communication is generated by the user or by another contact. Within this context, the system may keep the assessed tie strength between the user and the contact unchanged. Alternatively, the system may increase the assessed tie strength between the user and the contact when it is determined that the high frequency of messages from the user to the contact are responded to by the contact at a high frequency (e.g., an average of two out of three messages, or at a higher responsiveness rate than the contact usually responds to messages) and/or are responded to within a short amount of time (e.g. within five minutes, or within a shorter amount of time than the contact usually waits before responding to other contacts).

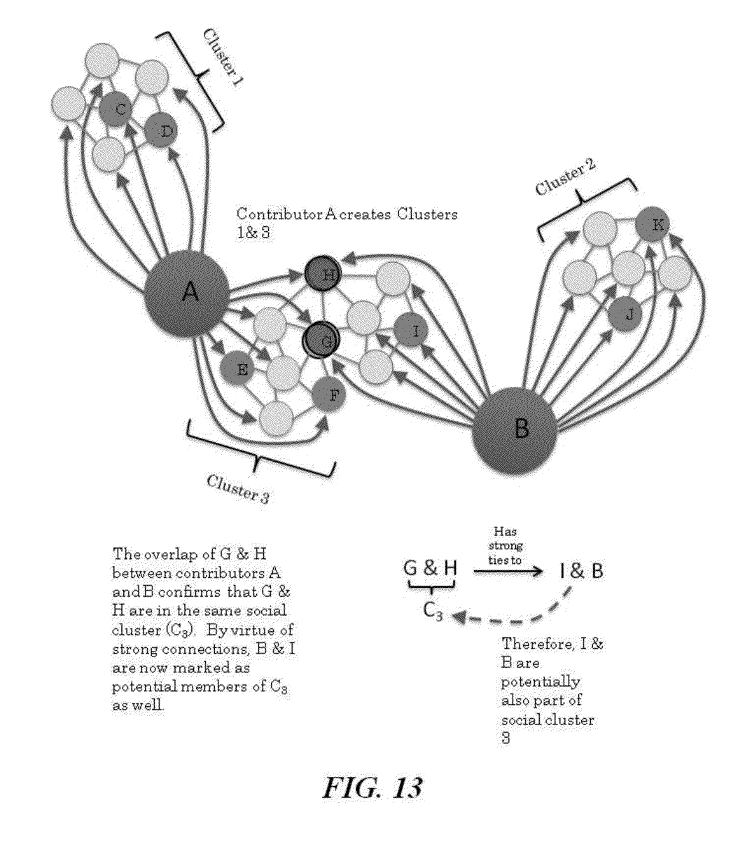

The system can implement social clusters to determine connections between contacts, which can be used to grow a contacts list of a user. Social clusters may be used to drive tie strengths between contacts that share clusters. In an example, a first user has a first set of contacts and a second user has a second set of contacts. The overlap between the first set and the second set can determine that users common to the first and second sets are part of the same cluster. In FIG. 13, for instance, contacts G and H are both tied to users A and B. The system determines that G and H belong to the same social cluster. User B may be determined to be part of the same social cluster as G and H. Contact I, which is tied to user B, may also be determined to be part of the same social cluster as G and H. Contact I may be in the same social cluster as G and H based on the strength of the connection between I and B, G or H.

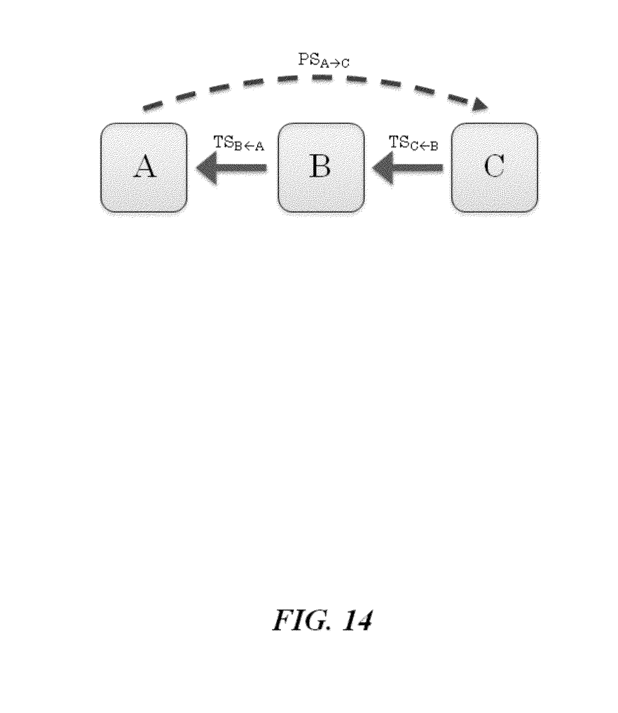

The system can identify the most closely tied intermediaries between a user and a target user, and provide an analysis of the strongest path(s) to determine what second level information is available for the target user, or whether the target is a contact of the user. The system can leverage cluster assignments to generate relationship paths (friends of friends) between users that are not part of the system. For example, in FIG. 14, the system determines the path strength between a user (A) and a target user (C) through an intermediary (B). The path strength can be determined by the tie strengths from the target (C) to intermediary (B) and from the intermediary (B) to the user (A). The path strength may be higher than the direct tie strength between A→C. Higher path strengths may override lower tie strengths.

Contact may be organized contextually. The system can organize the results of search queries depending on the context of the queries, so that a query such as “lives in San Francisco” returns results that are (inversely) sorted by the user's tie strength to the contacts, while a query such as “met last week” returns results that are (inversely) sorted by the date and time of the meetings. When a user views the profiles of the user's contacts, the user is also able to view the context of the user's relationships with the contacts. For example, if the contact studied at a particular university, the system (through the application) can show the other mutual friends that also went to that university. If the user and the contact studied at the same university at the same time, the application can also display that information.

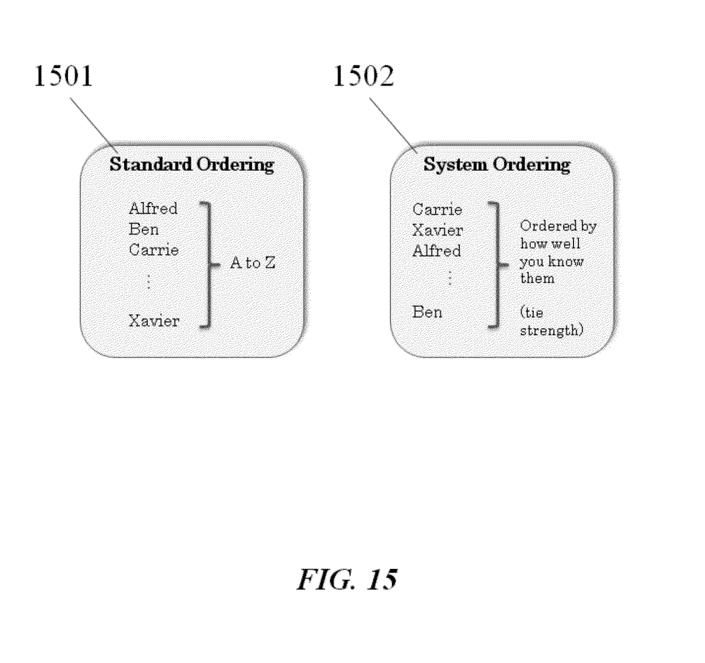

FIG. 15, for example, shows two contact lists, a first list 1501 and a second list 1502. In the first list 1501, contacts of a user are sorted alphabetically from A to Z. In the second list 1502, the contacts of the user are ordered by tie strength to the user. In the second list 1502, contacts that have a higher assessed tie strength to the user are toward the top of the list. The order of the list can vary based on context. For example, in a first city the second list 1502 may have a certain order, with contacts that are in or near the first city being towards the top of the second list 1502, and in a second city the second list 1502 may have a different order, with contacts that are in or near the second city being towards the top of the second list 1502. Such contact list that can change based on context can advantageously enable the system to display the most relevant contacts of a user.

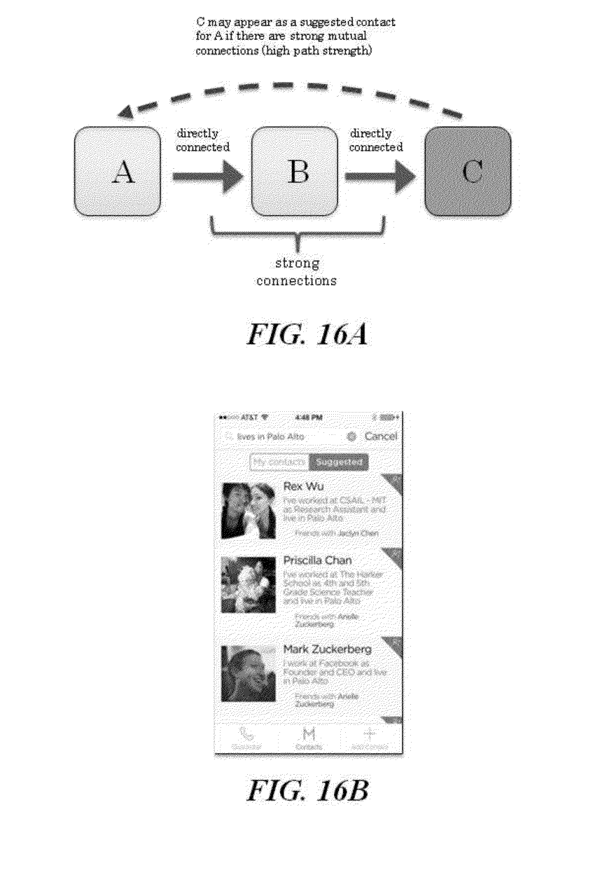

The system can provide contacts suggestions to the user. The system can display information about certain contacts with which the user is not directly connected, but which contacts may have a high path strength, which may be determined based on the mutual connections. For example, in FIG. 16A, B is a contact of user A, and C is a contact of B. The system may suggest C as a contact for A if the system determines that there is a strong mutual connection (high path strength) between A and C. FIG. 16B is a screenshot in which the system has suggested various potential contacts to the user.

The system can provide various features for enabling a user to find potential contacts, such as by contact information or location. For instance, the system can provide reverse number (or email) lookup within social network constraints. In such a case, the user can provide a phone number or email to the system (e.g., in a query field of the application), and the system can provide information about any potential contacts with which the user is not directly connected, but to which the user may have a high path strength strong (based, for example, on mutual connections), and the context of that potential relationship (e.g., the mutual connections that the user and the potential contact share). The level of visibility can be set by the potential contacts. For instance, a given contact can elect to not be discovered by users that are not directly connected to the contact.

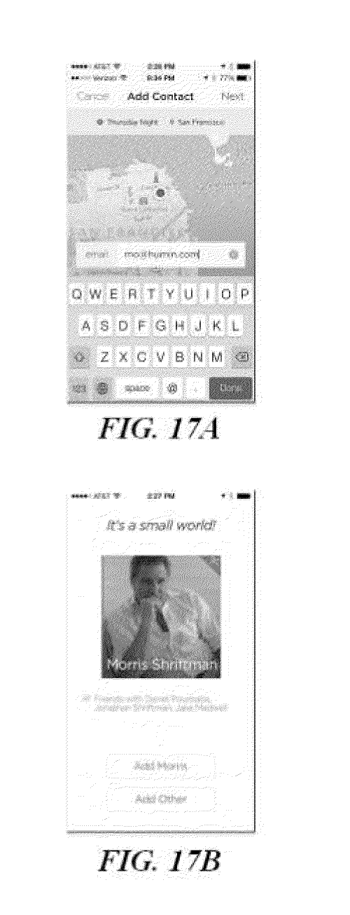

FIGS. 17A-17B are screenshots of an example in which a user performs a reverse email lookup for a potential contact. In FIG. 17A the user inputs an email address of a potential contact. The system may then reverse look up the email of the potential contact across networks, such as Facebook® or LinkedIn®. This reverse lookup may then lead to additional commonalities that provide contextual relationships and/or lead to additional information that leads to additional contextual relationships when the information is analyzed by GlobalID generation in association with other contacts. This analysis may be performed at a server of the system or may be performed at the user's electronic device.

Additionally, in FIG. 17B the system returns information about a potential contact including the name of the contact, a picture, and a list of mutual friends for that user and that contact. The system then enables the user to add the potential contact to the contacts database of the user. In particular, the user may receive a user interface (UI) designed to request whether the user wants to add the potential contact to the contacts database of the user. Alternatively, the user may have enabled a rule that automatically adds potential contacts to the contacts database of the user.

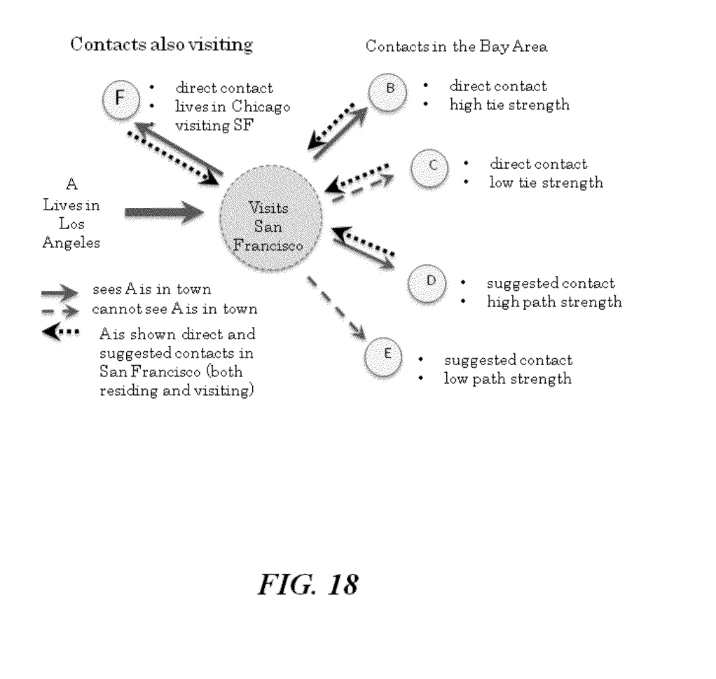

With reference to FIG. 18, when a user (A) is traveling away from her home city, the system through the application displays which of her contacts may be in that city (whether they live in that city or are visiting). The system can show the contacts of A that are users of the system when A is visiting their city. Such feature may be limited to users with high tie strengths or strong mutual connections to A.

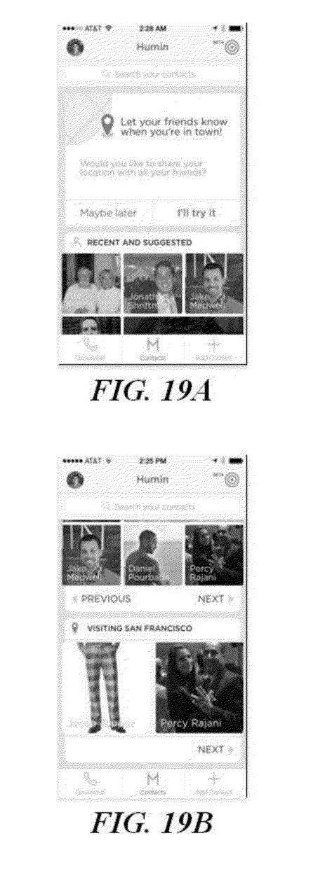

FIGS. 19A-19B are screenshots of location-based social discovery. In FIG. 19A, the system permits the user to let contacts (or friends) of the user know when the user is visiting them. If the user elects this feature, the system can notify contacts of the user when the user is at or near their locations. In FIG. 19B, the system presents the user with contacts that are visiting San Francisco, which is the present location of the user. In some situations, the system can present the location of the user or contacts of the user on a map.

In another example, the system may provide the user with a notification when a contact of the user is planning to be near the user's geographic location, or when the contact is already near the user's geographic location. This feature may be used when the user has contacts who are travelling from a separate city to the user's city, or the feature may be used for contacts generally. In another example, the notifications may be based on the context of the geographic location where the user is located. For example, the user may request that such notifications are not provided when the user is at home, or the user may initiate a “quite mode” for such notifications when the user is otherwise busy. In contrast, the user may affirmatively request that contacts notify her when they are nearby when she is studying in a library, or when she is sitting in a coffee shop. In this way, the user may control the interactions and notifications that she has with her contacts. Additionally, the user may implement similar rules for notifying her contacts when she is in their nearby vicinity. For example, if the user is busy, she may block notifications to her contacts that she is nearby. Alternatively, if she has free time then she may prefer to notify friends who may be nearby that she is available to meet with them.

The system can enable a user to invite other users or contacts to the system. The system can provide the user with a network driven smart invite list, which can be based on the local network characteristics of the user and the potential invitees (e.g., number of mutual friends, number of close mutual friends, number of different network clusters represented by the set of all invitees), the global network position of the user and the potential invitees (e.g., network centrality, network betweeness), the individual and dyadic characteristics of the user and the potential invitees (e.g., age, age difference between contacts, gender, gender difference), and multiple varied objectives reflected in the invite suggestion order (total adopters, diversity of the adopting population, total invites sent, diversity of the invitees to whom invites were sent, the likelihood of sending a given number of invitations). The system can build and train AI and machine learning algorithms to take these and other features as inputs and produce a user by user invite list that maximizes either local or global objective functions. An example of a local objective function is to encourage the most (or the most demographically or network structurally diverse) contacts of the current user to sign up for the service. An example of a global objective function is to encourage the most (or the most demographically or network structurally diverse) contacts in the population of all possible users to sign up for the service.

Systems of the present disclosure can provide various levels of privacy. In some embodiments, a system that facilitates the management of user contacts enables the user to manage (e.g., search, add, delete, or edit) contacts on an electronic device of the user. Such contact information may not be stored on a central computer system, such as a computer server.

In some situations, the user's credentials for the various sources of contact information (e.g., social network accounts) are maintained on the electronic device of the user and are not stored on a central computer system, such as a computer server. In such a case, users are not able to access the phone numbers, email addresses, street addresses of each other without the owner explicitly sharing such information. The user can customize which of their contacts can see their information (such as work history, education history, and relationships), and the level of information accessible to a given contact can be determined by the user. The user can customize which data each of their contacts can see, e.g., a user can specify that only relationships above a certain tie strength are visible to other users; another user may specify that none of her relationships are visible to other users; and a third user may allow other users to see all his relationships. The user can customize which communication method each of their contacts can use to contact the user by default.

Users may regulate which others users can have access to their contact information. In some situations, the personal contact information or relationships of users is not accessible to administrators of the system.

Systems of the present disclosure can permit maximum data security. User data that is transmitted from an electronic device of a user to a computer server may be encrypted for data security. The encryption may be done for the transmission process or when storing the data on the server or both. Additionally, the data can be segmented on the server such that access to any one segment does not provide any complete data. For example, one segment may contain information about contacts but not about addresses or about relationships between contacts.

### User Interfaces

Another aspect of the present disclosure provides contact cards that present information of contacts to a user. The contact cards can be displayed on a user interface of an electronic device of the user, such as a graphical user interface (GUI) or a web-based user interface. The UI can be implemented by an application that is programmed or otherwise configured to display contacts, organize contacts, and manage contacts, either in a standalone fashion, or with the aid of a system coupled to the electronic device, such as a server.

In some situations, contacts are presented via contact cards. Contact cards can be user interface elements that contain an array of contacts that can be relevant to the user based on, for example, contextual criteria and temporal triggers. A contact card can be a visual representation of a search query. The array of contact cards can be ordered by relevance to the user.

Contact cards can present various levels of information to the user. The information can be with respect to a given contact or information that is relevant to the user. For example, a meeting today card can display contacts with whom the user is attending a calendar event. This card can be paginated by event, and can include event attendees, event name, time, subject matter and location. This information can be displayed on the UI in a manner such that, when tapped or otherwise accessed by the user, directs the user to a search results page for the corresponding search query (e.g., “meeting today at <time>”).

As another example, a visiting contact card can display contacts who are in the same geographic location (geolocation) as the user and do not live in that city according to their social network or other profile(s) or information. In some situations, such contacts are users of the system and can have profiles on the system. Such contacts may have given the system permission to share (via appearing in this card) with their contacts when they are in town. This card can be paginated if there are more than two contacts.

As another example, a contact card can display contacts who live in a geographic location that the user is currently in, such as, for example, according to a social network profile or other profile(s) or information of the user, if that geographic location is not the user's home. This card can have a utility area that navigates to a search results page for the corresponding search query (e.g., “lives in <current city>”). This card can be paginated if there are more than two contacts.

In another example, a recent and suggested contact card can display contacts who the user has recently contacted, recently added, communicates with frequently, is within close proximity to, has a meeting with, or has high tie strength with. This card can be paginated if there are more than 1, 2, 3, 4, 5, 6, 7, 8, 9 or 10 contacts.

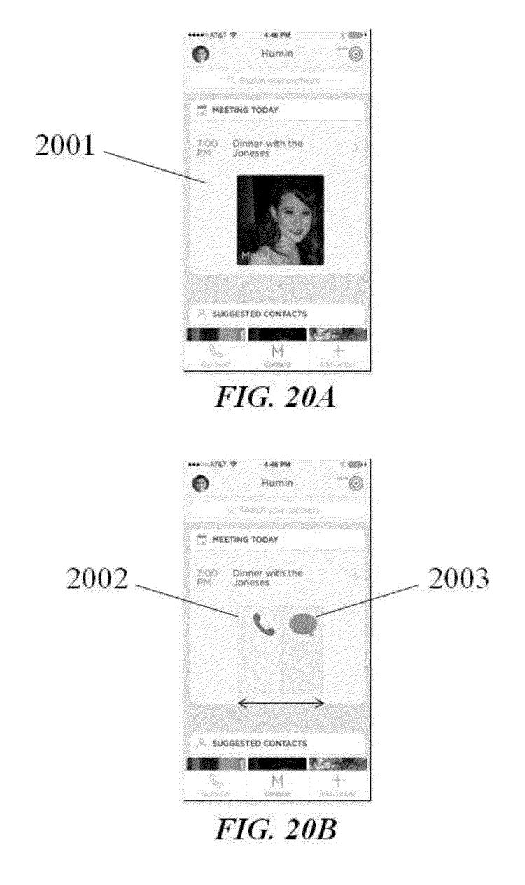

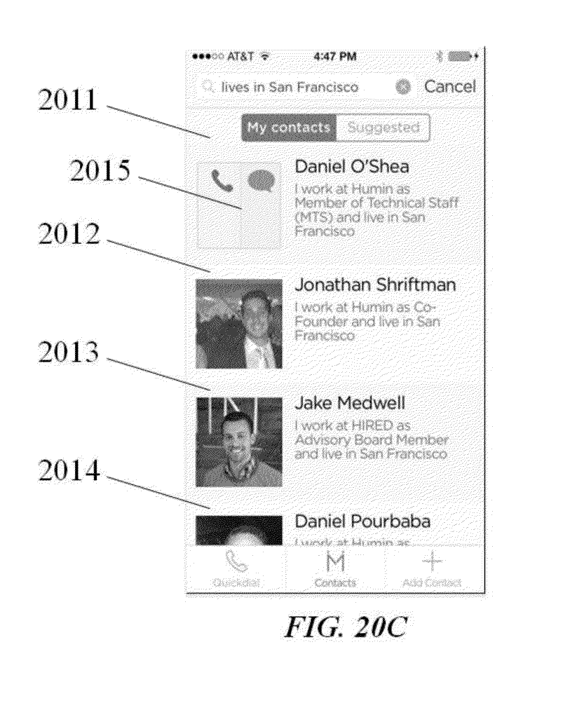

User interfaces of the present disclosure can provide users with various features and functionalities. For example, a contact card displaying a given contact (e.g., a picture of the contact) can enable the user to communicate with the contact. In some cases, the user can select an image, likeness, avatar or graphical element of or associated with the contact (e.g., a picture of the contact), and the UI may present the user with the ability to call, text or email the contact. In FIG. 20A, for instance, a contact card 2001 displays a picture of a given contact. The contact card in this example also displays an event (“Dinner with the Joneses”) associated with the contact. The user can select the picture (e.g., hold her finger on the picture) to display the UI element of FIG. 20B, which enables the user to call 2002 or text 2003 the contact by dragging left or right (along the direction of the arrows in the figure).

FIG. 20C is a screenshot of a user interface that shows contact cards 2011, 2012, 2013 and 2014. In contact card 2011, the user has selected the picture of the contact associated with contact card 2011 and the user interface presents the user with the option 2015 to communicate (e.g., call or text) the contact.

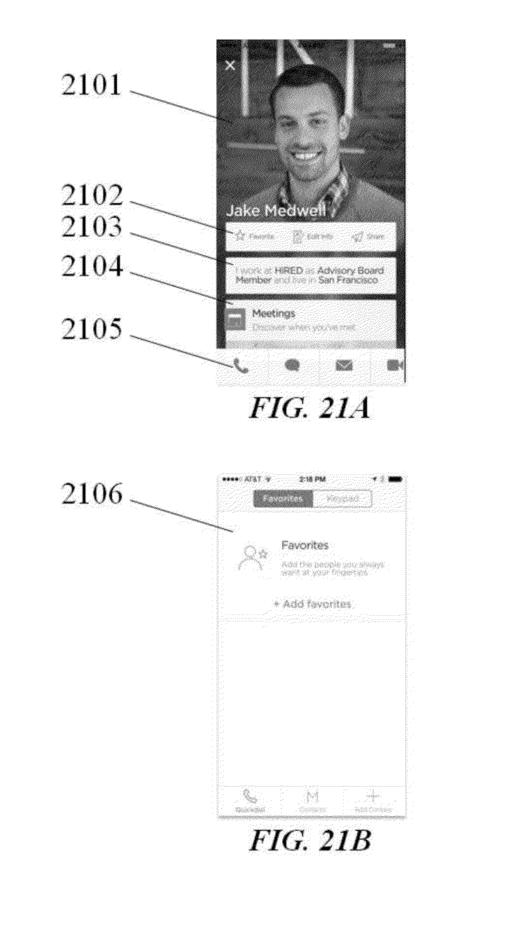

FIG. 21A shows a contact card that displays a picture 2101 of a contact of the user, a menu bar 2102 with various features (e.g., Favorite, Edit Info and Share), certain information 2103 of the contact, and relevant information 2104 of the contact. The relevant information displays a scheduled meeting between the user and the contact associated with the contact card. A menu bar 2105 presents the user with the ability to communicate with the contact, such as by phone, text message, email, or video conference (or video chat). In FIG. 21B, the user has selected “Favorite” from the menu bar 2102 and the user interface presents the user with the ability to add the contact to a list 2106 of favorite contacts of the user.

### Verification

Systems of the present disclosure can also be used to verify that the contact information a user has for a contact is correct. Additionally, the system can verify that updated contact information a user has for a contact is correct. A verification process may be performed across some or all of a user's contacts to determine which information she has for her contacts is correct and/or is still correct. Contact information that may be verified includes phone numbers, email, and street addresses as examples.

In particular, a user interface (UI) design may be provided that allows for a user to request verification for particular contacts. Additionally, a UI design may be provided for a user to receive verified information. The verified information that the user receives may be a summary of verified information (e.g., “All known contact information for contact B has been verified”) or the verified information may be detailed information (e.g. “The phone number for contact B has been verified as comprising 217-555-2514”). Additionally, a UI design may be provided for a contact to respond to the verification request. In particular, the UI design may include a way for the contact to confirm/deny/change a phone numbers/change an email address/change a street address.

In addition to having UI designs for interacting with a contact so as to update contact information, rules may be provided to instruct the system when to send emails (or other forms of communication) and/or under what conditions to interact with a contact so as to update their contact information. In particular, rules may include looking at a tie strength between a user and a contact and determining the type and/or frequency of an update email based on this determination.

Additionally, rules may involve utilizing lockers when sending contact update requests to contacts. A locker is a staging area where a request is held for an amount of time before being sent out. Lockers may also be used to receive and bundle requests so that a number of requests generated over a certain number of hours or days may be stored at the locker and sent to a recipient in one email or one series of consecutive emails. In this way, the contact may be provided with requests at or around the same time so that the contact does not get overwhelmed or annoyed by too many contact update requests.

The ability to use lockers when sending out contact update requests also allows the system to control the timing of the update requests. In this way, update requests may be sent in a coordinated manner so as to encourage the contact to respond promptly and completely. This is especially true for contacts who may be listed as separate identities within the system. As such, the responsiveness of the contact may be used to indicate that two identities that were suspected as both belonging to the contact are actually the same person given that the contact update requests were both responded to during the same window of time (e.g., 5 minutes or 20 minutes or an hour). Additionally, the coordination also prevents the contact from getting repeat messages that may annoy the contact, and instead the contact may receive one coordinated series of contact update requests.

The server may also use the sent contact update requests as a way to auto-verify the email address of the user is working and/or is being checked. This auto-verify may occur based on a responsive email being sent back to the server, a read request being acknowledged by the contact, or by another method of auto-authentication of an email.

The server may also design the contact update requests to be tailored to the information that is already accessible to the user. For instance if a user had a contact's phone number and email, but not the contact's home address, the server may send a contact update request to the contact to update her phone number and email, but not her home address. This may be beneficial to ensure that the users do not get too much extraneous information, as well as to ensure the privacy of the contact's information.

### Algorithms

Systems of the present disclosure can implement various algorithms for contact management. Such algorithms can be implemented by way of software stored in a memory location, which can be executed by a computer processor.

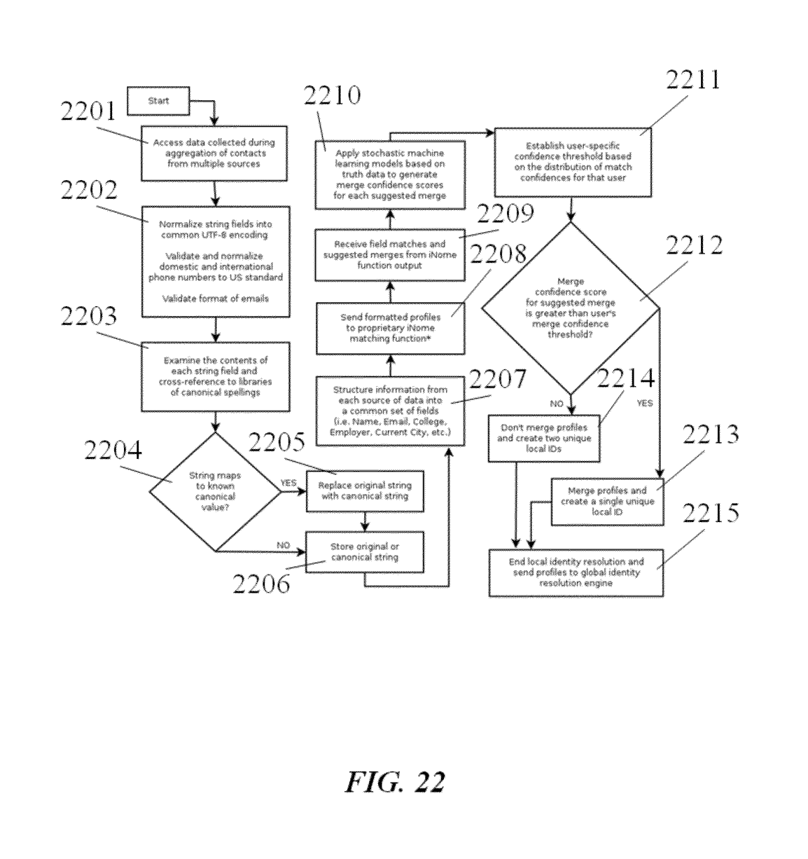

FIG. 22 shows an algorithm for local identity resolution. In a first operation 2201, the system accesses data collected during aggregation of contacts from various sources, such as social media and local source. In a second operation 2202, the system normalizes string fields, such as into common UCS Transformation Format (UTF) encoding. The system can validate and normalize domestic and international phone numbers to a certain standard. The system can also validate formats of emails. Next, in a third operation 2203, the system examines the content of each string field and cross-references to libraries of canonical spellings. In a fourth operation 2204, the system determines if the string maps to a known canonical value. If ‘yes’, then in a fifth operation 2205 the system replaces the original string with a canonical string. If ‘no,’ then in a sixth operation 2206 the system stores the original or canonical string. In a seventh operation 2207, the system gathers structure information from each source of data into a common set of fields (i.e., name, email, college, employer, current city, etc.). In an eighth operation 2208, the system sends formatted profiles to a matching function that determines if two records from different sources should be merged. In a ninth operation 2209, the system receives field matches and suggested merges from the function output. In a tenth operation 2210, the system applies one or more stochastic machine learning models based on truth data to generate merge confidence scored for each suggested merge. Next, in an eleventh operation 2211, the system establishes a user-specific confidence threshold based on the distribution of match confidences for the user. In a subsequent twelfth operation 2212, if the merge confidence score for a suggested merge is greater than a user's merge confidence threshold, then in a thirteenth operation 2213, the system merges profiles and creates a single unique local identification (ID). Otherwise, in a fourteenth operation 2214, the system does not merge profiles but creates two unique local IDs. In a fifteenth operation 2215, the system ends local identity resolution and sends profiles to a global identity resolution engine.

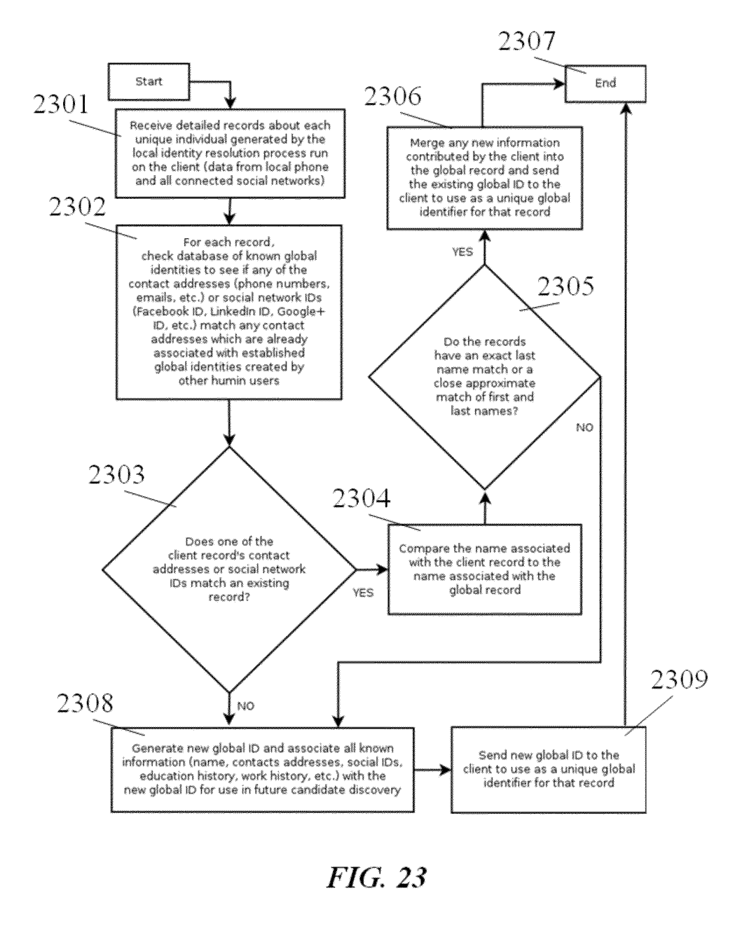

FIG. 23 shows an algorithm for GlobalID generation. In a first operation 2301, the system receives detailed records about each unique individual generated by the local identify resolution process run on an electronic device of the user (client), such as a Smart phone. Next, in a second operation 2302, for each record, the system checks the database of known global identities to see if any of the contact addresses (e.g., phone numbers, emails, etc.) or social network ID's (e.g., Facebook® ID, LinkedIn® ID, Google+® ID, etc.) match any contact addresses which are associated with established global identities created by other users. Next, in a third operation 2303, the system determines if any of the client record's contact addresses or social network ID's match an existing record. If ‘yes,’ then in a fourth operation 2304, the system compares the name associated with the client record to the name associated with the global record. Then, in a fifth operation 2305, the system determines if the records have an exact last name match or a close approximate match of first and last names. If ‘yes’, then in a sixth operation 2306 the system merges any new information contributed by the client into the global record and sends the existing global ID to the client to use as a unique global identifier for that record. The algorithm then ends at 2307. If, at operation 2303, the system determines that a client record's contact address or social network ID does not match an existing record, or at operation 2305 records do not have an exact last name match or a close approximate match of first and last names, then at operation 2308 the system generates a new global ID and associates all known information (e.g., name, contacts addresses, social ID's, education history, work history, etc.) with the new global ID for use in future GlobalID generation. Then, at operation 2309, the system sends the new global ID to the client to use as a unique global identifier for that record. The algorithm then ends at operation 2307.

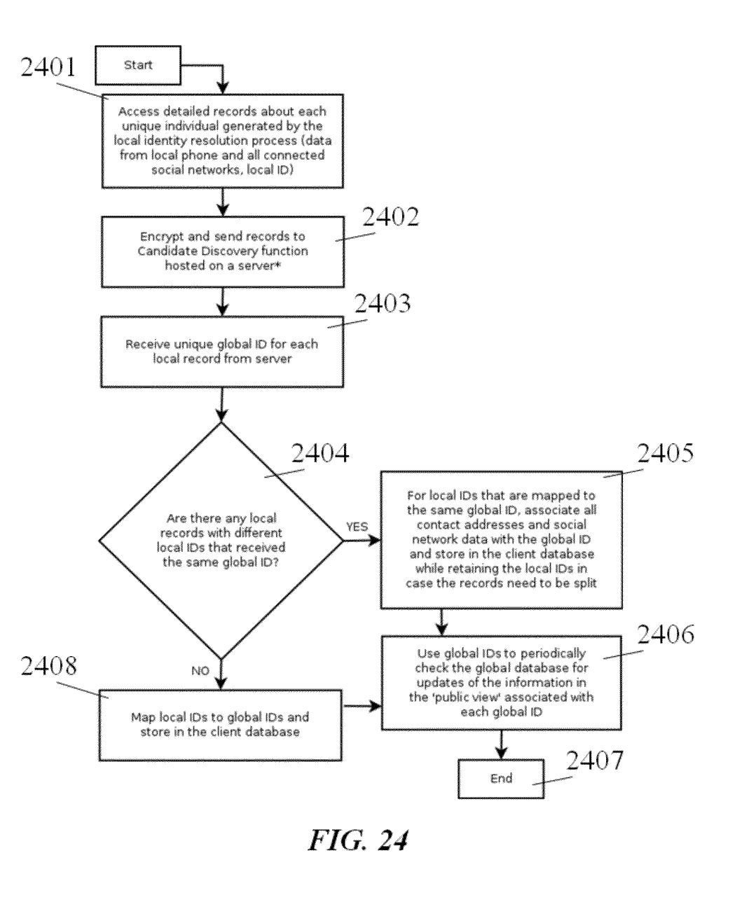

FIG. 24 shows an algorithm for global identity resolution. In a first operation 2401, the system accesses detailed records about each unique individual generated by the local identity resolution process (see, e.g., FIG. 22). Next, in a second operation 2402, the system encrypts and sends records to the GlobalID generation function hosted on a computer server (see, e.g., FIG. 23). In a third operation 2403, the system receives a unique global ID for each local record from the server. In a fourth operation 2404, the system determines if there are any local records with different local ID's that received the same global ID. If ‘yes’, then in a fifth operation 2405, for local ID's that are mapped to the same global ID, the system associates all contact addresses and social network data with the global ID and stores the data in a database of the client electronic device while retaining the local ID's in case the records need to be split. In some examples, records may be split based on types of information (e.g., email versus text communications), based on source of information (e.g., a social network versus a work email), or based on user input. In accordance with the design and categorizations of information associated with a contact's global ID, a user may request that the contact information of a contact's global ID is split along the lines described above or along different lines.

Next, in a sixth operation 2406, the system uses global ID's to periodically check the global database for updates of the information in public view associated with each global ID. The algorithm then ends at 2407.

If, at operation 2404, the system determines that there are no local records with different local ID's that received the same global ID, then at operation 2408 the system maps local ID's to global ID's and stores the local ID's in the client database. The system then proceeds to the sixth operation 2406.

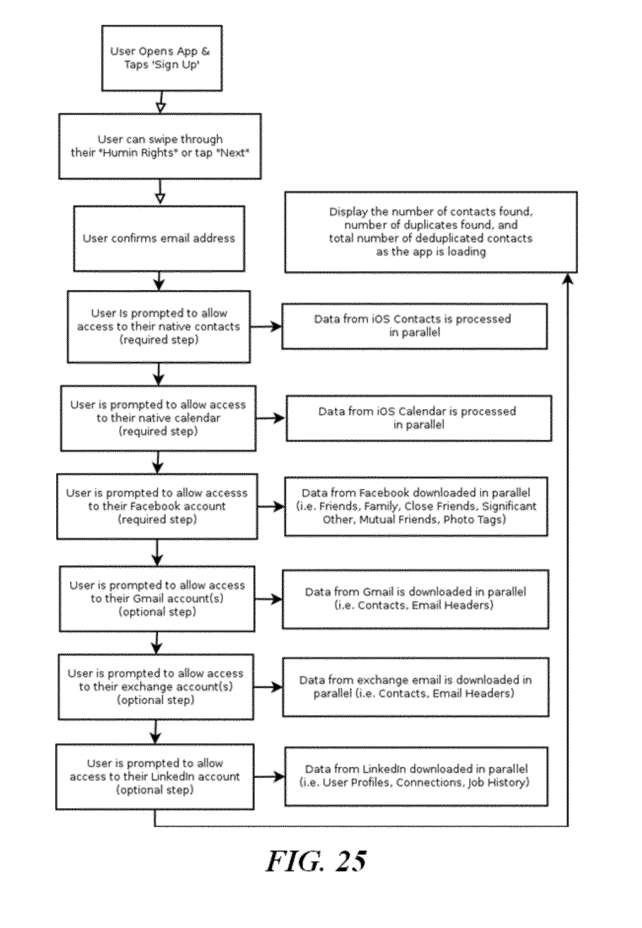

FIG. 25 shows an algorithm for contact aggregation from various sources, such as a local contacts list maintained on an electronic device of the user (client), a social network account (e.g., Facebook®) of the user, and an email account (e.g., Gmail®) of the user.

### Additional User Interfaces

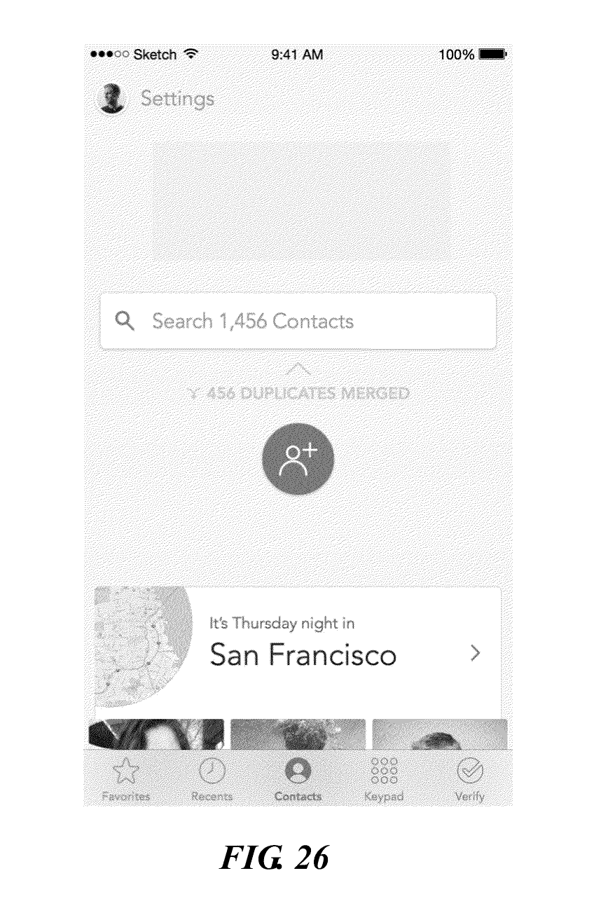

FIG. 26 is a screenshot of a main interface of an application (“app”), which may be executed on a mobile electronic device of a user. In particular, FIG. 26 is a screenshot of the ‘contacts’ tab, which serves as the primary interface through which users interact with the app. It shows a search bar that allows users to perform contextual searches across some or all of their contacts; an ‘add contact’ button to quickly store the contact information of a new connection; and contextually relevant ‘cards’ that surfaces contacts that the user may want to contact at that moment. In addition, it displays metrics related to identity resolution (e.g. removal of duplicate contacts) and enables the user to navigate to other parts of the app.

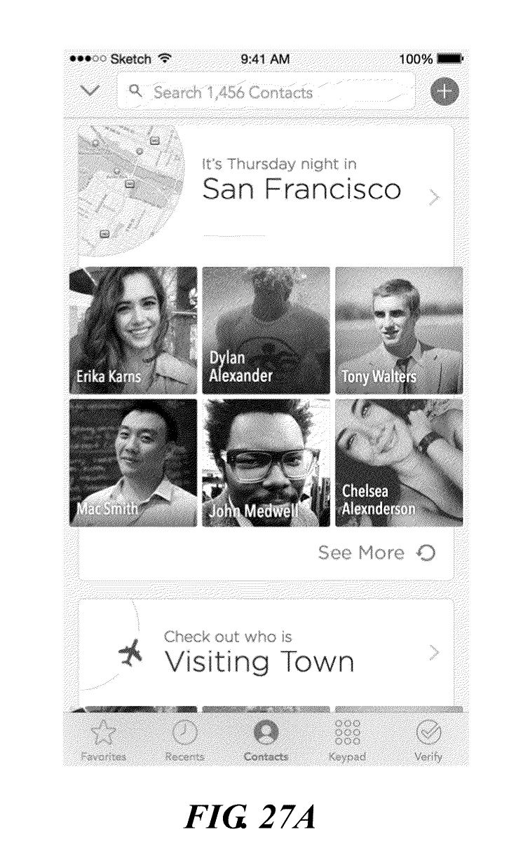

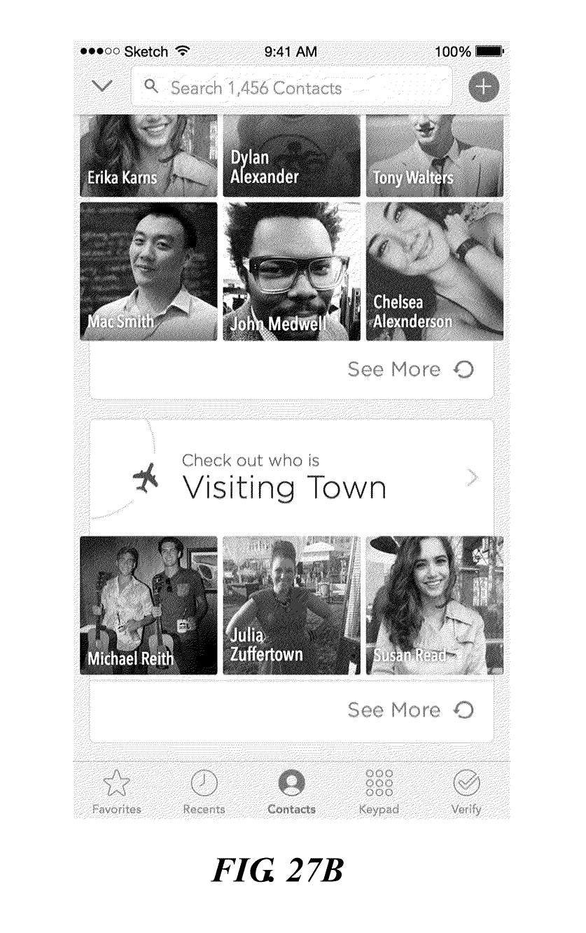

FIG. 27A is a screenshot that shows an example “lives-in card.” In particular, FIG. 27A shows a dynamic card that surfaces relevant contacts based on historical user behavior as well as temporal and geographic context. Additionally, FIG. 27B is a screenshot that shows an example “visiting card.” In particular, FIG. 27B shows a “visiting card” that notifies the user if they have contacts that live a significant distance from their location but are currently co-located with the user.

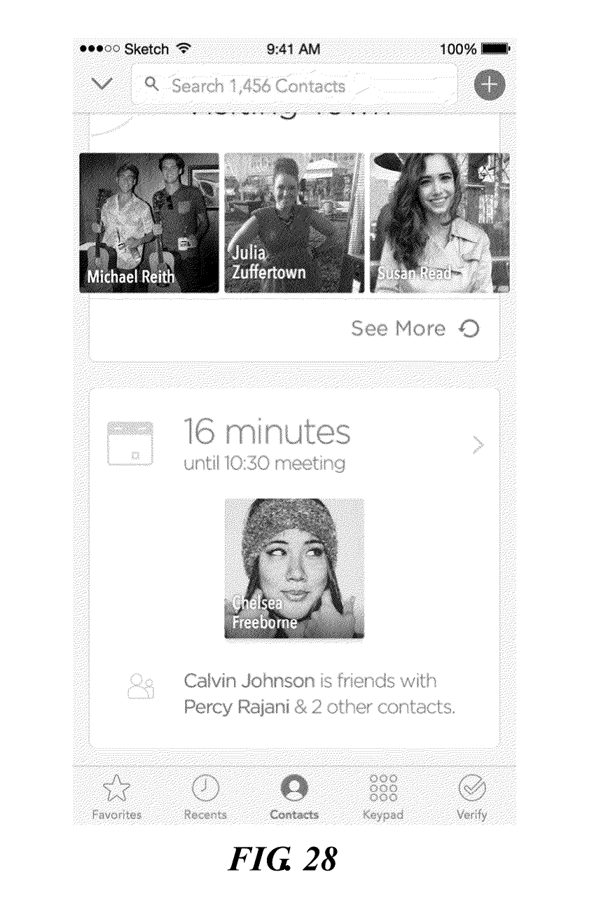

FIG. 28 is a screenshot of a “meeting card” with relevant information about an upcoming event. In particular, relevant information about upcoming events as shown in FIG. 28 may include the time, location, and contacts involved with the event as well as providing contextually relevant relationships shared by the participants.

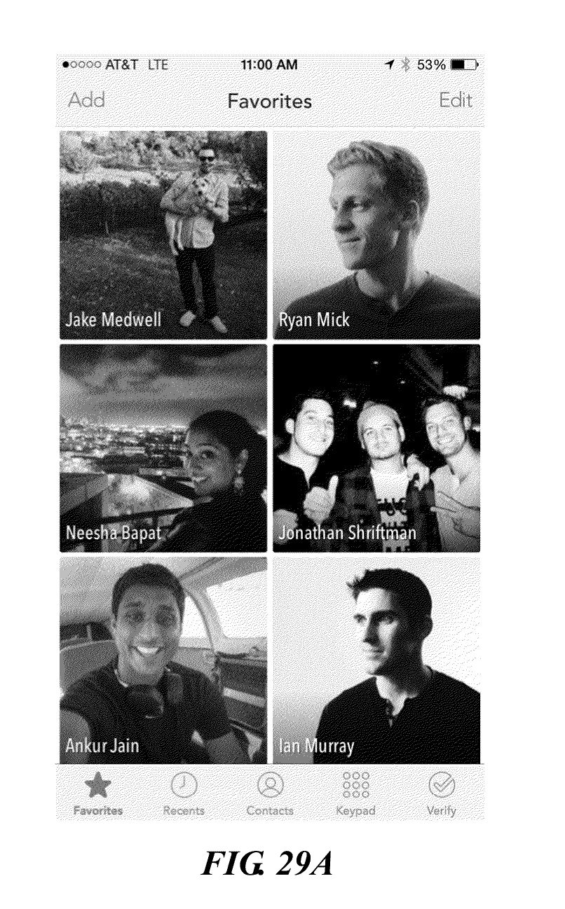

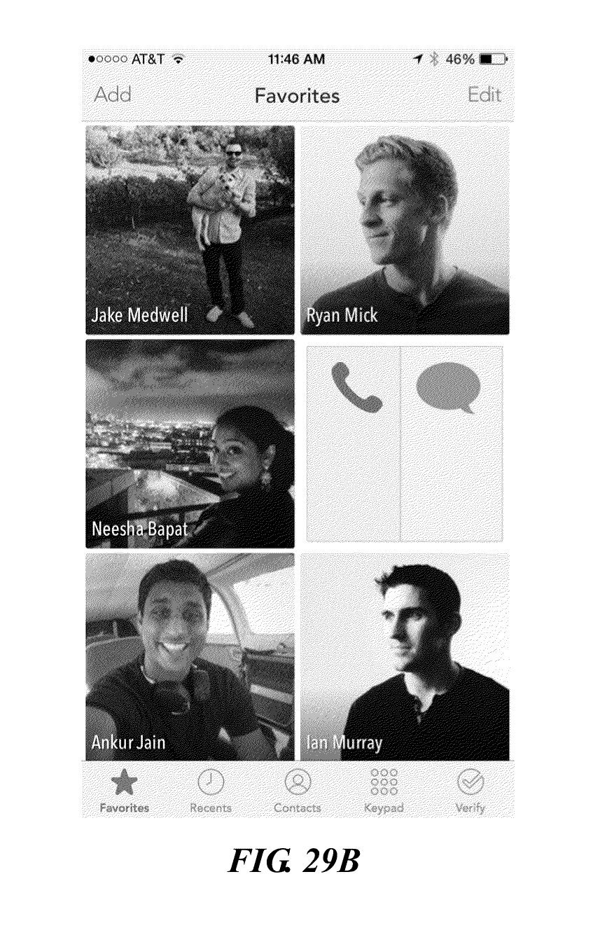

FIG. 29A is a screenshot of a favorites tab of an application. In particular, FIG. 29A shows the ‘favorites’ tab of the app where a user may curate a list of contacts with which they have frequent communication. FIG. 29B is a screenshot highlighting a ‘quick-call-text’ feature of an application. In particular, FIG. 29B illustrates the ‘quick-call-text’ feature of the app that may be engaged by pressing on any photo of a contact in the app, making it faster and easier to initiate a communication.

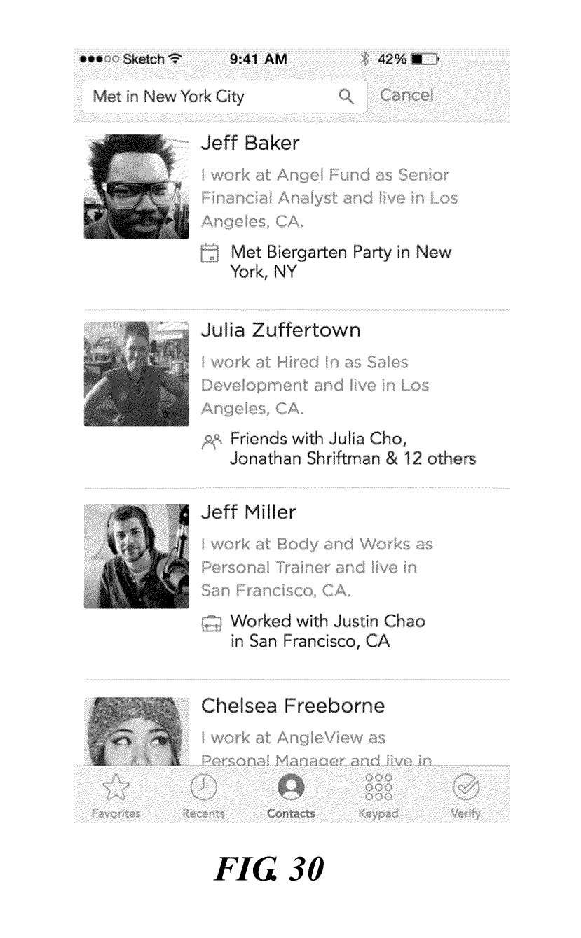

FIG. 30 is a screenshot showing search results ordered by relative importance of the contacts and giving contextually relevant information about each result. In particular, FIG. 30 shows an example set of search results displaying a variety of contextual information related to each contact returned by the search query.

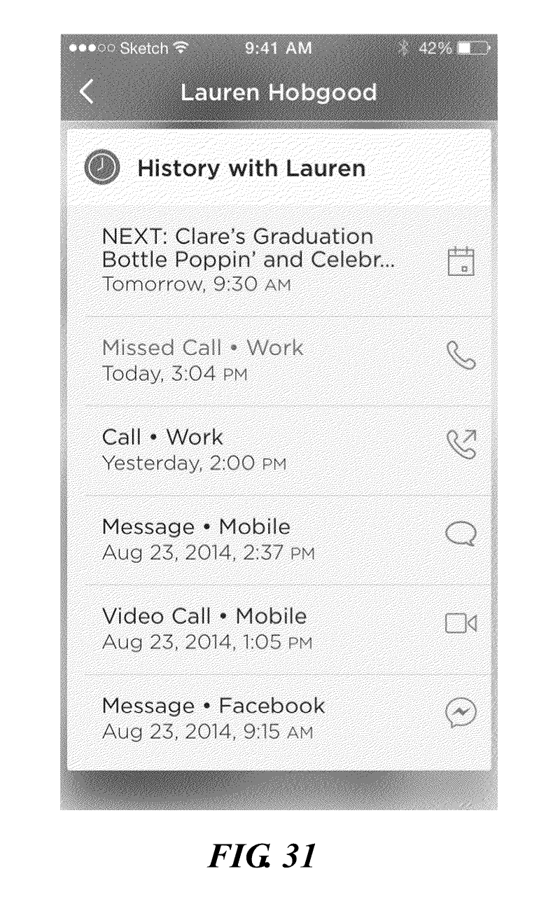

FIG. 31 is a screenshot of a “history card” shown in contact profiles. In particular, FIG. 31 shows a ‘history card’ which details a comprehensive history of meetings and communication from all possible channels (e.g. instant message, facetime, call, text, email, VoIP etc.).

### Computer Systems

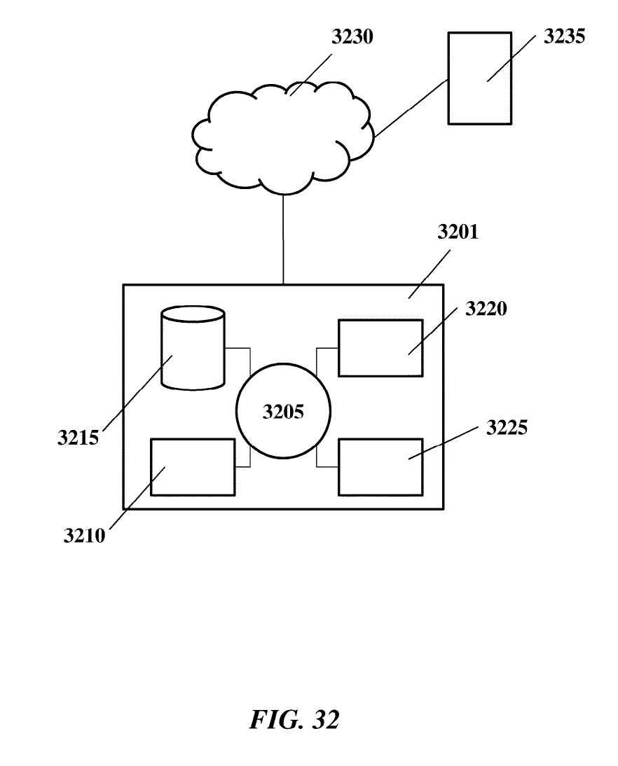

The present disclosure provides computer systems that are programmed to implement methods of the disclosure. FIG. 32 shows a computer system 3201 that is programmed or otherwise configured to manage contact information. The computer system 3201 can regulate various aspects of contact management of the present disclosure, such as, for example, accessing multiple sources for contact information, aggregating contact information, and generating a contact database. The contact database may be maintained on an electronic device of a user, or the computer system 3201.

The computer system 3201 includes a central processing unit (CPU, also “processor” and “computer processor” herein) 3205, which can be a single core or multi core processor, or a plurality of processors for parallel processing. The computer system 3201 can be an individual server or multiple servers. The computer system 3201 also includes memory or memory location 3210 (e.g., random-access memory, read-only memory, flash memory), electronic storage unit 3215 (e.g., hard disk), communication interface 3220 (e.g., network adapter) for communicating with one or more other systems, and peripheral devices 3225, such as cache, other memory, data storage and/or electronic display adapters. The memory 3210, storage unit 3215, interface 3220 and peripheral devices 3225 are in communication with the CPU 3205 through a communication bus (solid lines), such as a motherboard. The storage unit 3215 can be a data storage unit (or data repository) for storing data. The computer system 3201 can be operatively coupled to a computer network (“network”) 3230 with the aid of the communication interface 3220. The network 3230 can be the Internet, an intranet and/or extranet, or an intranet and/or extranet that is in communication with the Internet. The network 3230 in some cases is a telecommunication and/or data network. The network 3230 can include one or more computer servers, which can enable distributed computing, such as cloud computing. The network 3230, in some cases with the aid of the computer system 3201, can implement a peer-to-peer network, which may enable devices coupled to the computer system 3201 to behave as a client or a server.

The CPU 3205 can execute a sequence of machine-readable instructions, which can be embodied in a program or software. The instructions may be stored in a memory location, such as the memory 3210. Examples of operations performed by the CPU 2605 can include fetch, decode, execute, and writeback.

The storage unit 3215 can store files, such as drivers, libraries and saved programs. The storage unit 3215 can store programs generated by users and recorded sessions, as well as output(s) associated with the programs. The storage unit 3215 can store user data, e.g., user preferences and user programs. The computer system 3201 in some cases can include one or more additional data storage units that are external to the computer system 3201, such as located on a remote server that is in communication with the computer system 3201 through an intranet or the Internet.

The computer system 3201 can communicate with one or more remote computer systems 3235 through the network 3230. For instance, the computer system 3201 can communicate with a remote computer system of a user, such as a user having a contact database with one or more contacts. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 3201 via the network 3230.

Methods as described herein can be implemented by way of machine (e.g., computer processor) executable code stored on an electronic storage location of the computer system 3201, such as, for example, on the memory 3210 or electronic storage unit 3215. The machine executable or machine readable code can be provided in the form of software. During use, the code can be executed by the processor 3205. In some cases, the code can be retrieved from the storage unit 3215 and stored on the memory 3210 for ready access by the processor 3205. In some situations, the electronic storage unit 3215 can be precluded, and machine-executable instructions are stored on memory 3210.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 2601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 3201 can include or be in communication with an electronic display that comprises a user interface (UI) for providing, for example, contacts. Examples of UI's include, without limitation, a graphical user interface (GUI) and web-based user interface.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for contact management from multiple sources of contact information, comprising
(a) retrieving, with a mobile electronic device of a user, contact information from multiple external sources of contact information over a network;
(b) storing said contact information in a memory location of said mobile electronic device;
(c) determining with a computer processor whether contact information from a portion of said multiple sources at least partially overlaps with contact information from a remainder of said multiple sources;
(d) based on said determining of (c), (i) if there is overlap between said portion of said multiple sources and said remainder of said multiple sources, merging overlapping contact information to generate a consolidated contact record corresponding to a distinct contact, which consolidated contact record has a single set of contact information, or (ii) if said contact information is indicative of two distinct contacts, splitting said contact information to generate split contact records for said two distinct contacts having different sets of contact information; and
(e) storing said consolidated contact record or split contact records in a memory location having a database of contact records of said mobile electronic device.

2. The method of claim 1, further comprising determining a level of overlap between said portion of said multiple sources and said remainder of said multiple sources, and merging said overlapping contact information if said level of overlap is greater than 50%.

3. The method of claim 1, wherein at least one of said multiple external sources of contact information is a social network in communication with said mobile electronic device of said user.

4. The method of claim 1, wherein (a) further comprises retrieving contact information from a contact database on said mobile electronic device.

5. The method of claim 1, wherein said multiple external sources further includes an additional social network.

6. The method of claim 1, wherein (c) and/or (d) are performed without using a central computer server.

7. The method of claim 1, wherein (c) and/or (d) are performed by said mobile electronic device.

8. The method of claim 1, wherein said computer processor is a part of said mobile electronic device.

9. The method of claim 1, wherein said computer processor is a part of another electronic device.

10. The method of claim 9, wherein said another electronic device is a computer server.

11. The method of claim 1, wherein said contact information from said multiple external sources includes identifying information selected from the group consisting of name(s), physical address(es), electronic mail address(es) and telephone number(s).

12. The method of claim 1, further comprising displaying said consolidated contact record or split contact records on a user interface of said mobile electronic device.

13. The method of claim 12, wherein said consolidated contact record or split contact records are displayed on contact cards on said user interface.

14. The method of claim 1, wherein said consolidated contact record or split contact records include(s) contact information selected from the group consisting of contact name(s), physical address(es), electronic mail address(es) and telephone number(s).

15. A method for contact management from multiple sources of contact information, comprising
(a) retrieving, with an electronic device of a user, contact information from multiple external sources of contact information over a network, wherein said electronic device is not a central computer server;
(b) storing said contact information in a memory location of said electronic device;
(c) determining with a computer processor whether contact information from a portion of said multiple sources at least partially overlaps with contact information from a remainder of said multiple sources;
(d) based on said determining of (c), (i) if there is overlap between said portion of said multiple sources and said remainder of said multiple sources, merging overlapping contact information to generate a consolidated contact record corresponding to a distinct contact, which consolidated contact record has a single set of contact information, or (ii) if said contact information is indicative of two distinct contacts, splitting said contact information to generate split contact records for said two distinct contacts; and
(e) storing said consolidated contact record or split contact records in a memory location having a database of contact records of said electronic device.

16. The method of claim 15, wherein at least one of said multiple external sources of contact information is a social network in communication with said mobile electronic device of said user.

17. The method of claim 15, wherein (a) further comprises retrieving contact information from a contact database on said electronic device.

18. The method of claim 15, wherein (c) and/or (d) are performed without using a central computer server.

19. The method of claim 15, wherein (c) and/or (d) are performed by said electronic device.

20. The method of claim 15, wherein said computer processor is a part of said electronic device.

21. The method of claim 15, wherein said computer processor is a part of another electronic device.

22. The method of claim 21, wherein said another electronic device is a computer server.

23. The method of claim 15, further comprising displaying said consolidated contact record or split contact records on a user interface of said electronic device.

24. The method of claim 15, wherein said electronic device is in communication with other electronic devices of other users over said network.

25. A mobile electronic device programmed for contact management from multiple sources of contact information over a network, comprising:
a communication interface that brings said mobile electronic device in communication with multiple external sources of contact information, at least one of which multiple sources is a social network in network communication with said mobile electronic device over said network;
computer memory that stores contact information; and
a computer processor coupled to said communication interface and said computer memory, wherein said computer processor is programmed to (a) retrieve contact information from said multiple external sources; (b) store said contact information in said computer memory; (c) determine whether contact information from a portion of said multiple sources at least partially overlaps with contact information from a remainder of said multiple sources; (d) based on (c), (i) if there is overlap between said portion of said multiple sources and said remainder of said multiple sources, merge overlapping contact information to generate a consolidated contact record corresponding to a distinct contact, which consolidated contact record has a single set of contact information, or (ii) if said contact information is indicative of two distinct contacts, split said contact information to generate split contact records for said two distinct contacts; and (e) store said consolidated contact record or split contact records in said computer memory.

26. The mobile electronic device of claim 25, further comprising an electronic display coupled to said computer processor, wherein said electronic display includes a user interface that displays said consolidated contact record or split contact records.

27. The mobile electronic device of claim 26, wherein said user interface includes one or more graphical elements that differentiate said consolidated contact record or split contact records.
